(19) United States
(12) Patent Application Publication
(10) Pub. No.: US 2026/0134308 A1
(43) Pub. Date: May 14, 2026

(54) Systems and Methods for Prompting a Large Language Model based on a Subgraph

(71) Applicant: Renyooit LLC, Pleasanton, CA (US)

(72) Inventors: Lakshmi Nagarajan, San Ramon, CA (US); Raja Nagarajan, San Ramon, CA (US); Saisriram Natarajan, Santa Clara, CA (US)

(21) Appl. No.: 19/330,074

(22) Filed: Sep. 16, 2025

Related U.S. Application Data
(60) Provisional application No. 63/695,485, filed on Sep. 17, 2024.

(51) Int. Cl. G06N 5/04

(52) U.S. Cl. CPC G06N 5/04

(57) ABSTRACT

An example method for user interaction with media content includes receiving, by a chat interface, a user query and determining a query embedding for the user query. The method includes receiving feature vectors from a hierarchical structure of the media content; comparing the query embedding with the feature vectors; identifying one or more feature vectors similar to the query embedding. A feature vector identifies a node in a knowledge graph. Nodes represent entities and portions of media content, and an edge indicates a relationship between entities and portions of media content associated with two nodes. The method includes traversing edges of the knowledge graph; extracting a relevant subgraph including content relevant to the user query; providing the user query and the extracted relevant subgraph to a generative AI model, with instructions to generate a response; receiving a response from the generative model; and providing the response from the generative model.

### CROSS-REFERENCE TO RELATED DOCUMENTS

This application claims priority to U.S. Provisional Application No. 63/695,485, filed Sep. 17, 2024, the contents of which are incorporated herein by reference in their entirety.

### BACKGROUND

This application generally relates to using a large language model to provide responses to user queries.

### SUMMARY

This application involves devices, systems, and methods for using a large language model (LLM) to provide responses to user queries. Media content such as owner's manuals, financial reports, video and/or audio recordings often include many pages or minutes of content. Users interacting with this media may be faced with a large amount of content that is irrelevant to their query, making it difficult to quickly answer questions. For example, a conference recording may include hours of audio, much of which may be disorganized or unrelated to a user's topic of interest. Searching manually through the media can be time consuming and may require a sophisticated understanding of the media content. In a situation where a user is not sure if the information is available, manual searching is not only challenging, but it may also be futile.

One existing solution includes searching media content for specific terms. However, pertinent information may be spread across multiple portions of the media content and may not always use the language of a search term. Users searching by specific terms may therefore miss important context and information, resulting in incorrect conclusions from the media content. Additionally, users searching by specific terms are often unable to use natural language, which can be confusing or non-intuitive.

Accordingly, there is a need for a query-response process where a user may be able to use natural language prompts to interact with media content and receive accurate responses that include information drawn directly from the media content. Existing approaches using a large language model involve processing a single piece of media content at a time and processing the entire piece of content. However, the language model may not be able to process multiple pieces of media content, and/or mixed media. Moreover, even in cases where multiple pieces of media content may be uploaded, the large language model parses the media, and this may result in inaccuracies (e.g., hallucinations), loss of context, and so forth, and result in responses that may not be helpful or accurate.

Without the certainty that a result will be correct, users are unable to utilize generative AI models for searching in a meaningful way. Additionally, current implementations may require the generative AI model to parse the entire piece of media to search for information, which is computationally expensive. In addition to a query-response process as described above, there is a need for a more reliable, efficient system for processing media.

The techniques described herein present a technical solution to a specific technical problem: the inefficiency and high computational cost of providing a factual, real-time basis for generative AI model responses using unstructured data. By generating a novel knowledge graph data structure from media content characteristics, the method transforms disorganized, multi-modal data into a structured format that enables accelerated retrieval and reduced computational overhead. The graph traversal process described herein offers a computationally efficient way to extract relevant information. Instead of traversing the entire graph (which can be massive), the traversal is limited to a small, highly relevant portion. This reduces the time and resources required to prepare the context for the LLM, leading to faster response times. This tangible improvement in a computer's functionality and performance goes beyond a mere abstract idea and/or the automation of a mental step.

As described herein, the media content may be preprocessed so that the data in the media content is transformed into a more readable, navigable, and annotatable presentation. Also, for example, the pre-processed media content may be used to generate a knowledge graph. In some embodiments, a user query is analyzed for intent and feature vectors are generated to represent the query and the intent. In some embodiments, the feature vectors may be used to identify one or more relevant subgraphs of the knowledge graph (or subgraphs from multiple knowledge graphs). In some embodiments the identified subgraphs may then be provided to a large language model along with the query to generate a response that may then be provided to the user.

As described herein, a knowledge graph may be combined with embedding models and large language models. In some embodiments, a given media content may be parsed into a hierarchical structure, and entities may be detected at each level of the hierarchy. One or more knowledge graphs may be used to capture such hierarchical structures and entity interrelationships. In some embodiments, the knowledge graphs may also include additional features of the document, such as audio characteristics, motion features, and so forth. The knowledge graph enables a strong focus on the context in the media content. Accordingly, a user query may be strongly linked to the context, thereby generating relevant, accurate, and contextual information. Such an approach also reduces and/or eliminates hallucinations by a generative AI model as the identified subgraph provides the information content to the generative AI model, preventing it from deviating from actual content.

Such an approach can enhance information retrieval tasks in an enterprise. For example, enterprise documents can be pre-processed, knowledge graphs may be generated (and updated as needed), and different documents may be interlinked together via different hierarchical nodes and links. Entities and links may be weighted based on relevance (contextual and otherwise). Such an approach also reduces costs as only a portion of the knowledge graph is sent to the large language model, instead of processing the entire document or multiple documents to process different queries.

A large language model is likely to generalize from information to generate a response that is unlikely to be accurate and may also not be relevant to a user query. Accordingly, the identifying of a relevant subgraph that includes information from the media content that is pertinent to responding to the user query is a significant technical improvement that solves these technical challenges. Providing a relevant extracted subgraph to a generative AI model will also prevent the generative AI model from generalizing content from across the larger knowledge graph. An extracted relevant subgraph focuses the data the generative AI model is given, so that it is less likely to pull information from unrelated areas of the media content, or to generate content that may be inaccurate. Additionally, the identifiers included in an extracted relevant subgraph help to ensure the generative AI model references specific nodes and pieces of information. Providing a relevant extracted subgraph therefore reduces the risk of hallucinations in responses to users. Such an approach allows for considerable savings in terms of computational resources (processor time, memory, data traffic, tokens, etc.), decreases response time, and increases accuracy and relevance of the response to the query.

For example, many product manuals (e.g., instruction manuals, owners'manuals, repair manuals, and so forth) are documents with multiple pages, and/or include highly technical diagrams, descriptions, and so forth. For example, product design documents can be somewhat confusing when a user applying the design in a manufacturing of the product, or in constructing the building, is not able to quickly retrieve information from the document, or view design features of various parts of the product, building, apparel, etc. Even when the information is available, such information may be challenging to find within a user manual and may require considerable time and effort on the part of the user to find the information, map it to their own product, understand the content, and then use the information.

User manuals, design documents, etc. may be lengthy, complex, and may include information that may not be relevant to the user at a particular point in time, or in response to a particular problem. Such user manuals, design documents, etc. may also make use of callouts that highlight specific points of images within the documents to provide additional context, or emphasis, or to link to textual information within the document. Also, for example, the information relevant to a specific topic or problem may not be available at one location in the document and may instead be spread throughout the document on many different pages.

In a first aspect, a computer implemented method for user interactions with media content by optimizing a retrieval of factual content for a generative artificial intelligence (AI) model is provided. The method includes receiving, by a chat interface of a computing device, a user query. The method also involves determining a query embedding for the user query, wherein the query embedding is indicative of an intent of the user query. The method further includes receiving a plurality of feature vectors from a hierarchical structure of the media content, wherein the hierarchical structure is based on a characteristic of the media content, and wherein a given feature vector of the plurality of feature vectors is associated with a portion of the media content. The method further includes comparing the query embedding with the plurality of feature vectors. The method further includes identifying, based on the comparing, one or more feature vectors that are similar to the query embedding, wherein the given feature vector is associated with an identifier that identifies a node in a knowledge graph, the knowledge graph comprising nodes and edges, wherein nodes represent entities and portions of media content, and an edge between two nodes is indicative of a relationship between respective entities and portions of media content associated with the two nodes. The method also includes traversing one or more edges of the knowledge graph, wherein the traversing is based on nodes corresponding to identifiers associated with the identified one or more feature vectors. The method also includes extracting, based on the traversing, at least one relevant subgraph of the knowledge graph wherein the at least one relevant subgraph comprises content relevant to the user query. The method further includes providing the user query and the extracted at least one relevant subgraph to the generative AI model, with instructions to generate a response based on the extracted at least one relevant subgraph. The method also involves receiving a response from the generative AI model, and providing, by the chat interface and in response to the user query, the response from the generative AI model.

In a second aspect, a computing device for user interactions with media content by optimizing a retrieval of factual content for a generative artificial intelligence (AI) model is provided. The computing device includes one or more processors and data storage. The data storage has stored thereon computer-executable instructions that, when executed by one or more processors, cause the computing device to perform functions. The functions include receiving, by a chat interface of a computing device, a user query. The functions also include determining a query embedding for the user query, wherein the query embedding is indicative of an intent of the user query. The functions further include receiving a plurality of feature vectors from a hierarchical structure of the media content, wherein the hierarchical structure is based on a characteristic of the media content, and wherein a given feature vector of the plurality of feature vectors is associated with a portion of the media content. The functions further include comparing the query embedding with the plurality of feature vectors. The functions also include identifying, based on the comparing, one or more feature vectors that are similar to the query embedding, wherein the given feature vector is associated with an identifier that identifies a node in a knowledge graph, the knowledge graph comprising nodes and edges, wherein nodes represent entities and portions of media content, and an edge between two nodes is indicative of a relationship between respective entities and portions of media content associated with the two nodes. The functions further include traversing one or more edges of the knowledge graph, wherein the traversing is based on nodes corresponding to identifiers associated with the identified one or more feature vectors. The functions further include extracting, based on the traversing, at least one relevant subgraph of the knowledge graph wherein the at least one relevant subgraph comprises content relevant to the user query. The functions also include providing the user query and the extracted at least one relevant subgraph to the generative AI model, with instructions to generate a response based on the extracted at least one relevant subgraph. The functions further include receiving a response from the generative AI model, and providing, by the chat interface and in response to the user query, the response from the generative AI model.

In a third aspect, a computer program for user interactions with media content by optimizing a retrieval of factual content for a generative artificial intelligence (AI) model is provided. The computer program includes instructions that, when executed by a computer, cause the computer to perform functions. The functions include receiving, by a chat interface of a computing device, a user query. The functions also include determining a query embedding for the user query, wherein the query embedding is indicative of an intent of the user query. The functions further include receiving a plurality of feature vectors from a hierarchical structure of the media content, wherein the hierarchical structure is based on a characteristic of the media content, and wherein a given feature vector of the plurality of feature vectors is associated with a portion of the media content. The functions further include comparing the query embedding with the plurality of feature vectors. The functions also include identifying, based on the comparing, one or more feature vectors that are similar to the query embedding, wherein the given feature vector is associated with an identifier that identifies a node in a knowledge graph, the knowledge graph comprising nodes and edges, wherein nodes represent entities and portions of media content, and an edge between two nodes is indicative of a relationship between respective entities and portions of media content associated with the two nodes. The functions further include traversing one or more edges of the knowledge graph, wherein the traversing is based on nodes corresponding to identifiers associated with the identified one or more feature vectors. The functions further include extracting, based on the traversing, at least one relevant subgraph of the knowledge graph wherein the at least one relevant subgraph comprises content relevant to the user query. The functions also include providing the user query and the extracted at least one relevant subgraph to the generative AI model, with instructions to generate a response based on the extracted at least one relevant subgraph. The functions further include receiving a response from the generative AI model, and providing, by the chat interface and in response to the user query, the response from the generative AI model.

In a fourth aspect, an article of manufacture for user interactions with media content by optimizing a retrieval of factual content for a generative artificial intelligence (AI) model is provided. The article of manufacture includes one or more computer readable media having computer readable instructions stored thereon that, when executed by one or more processors of a computing device, cause the computing device to perform functions. The functions include receiving, by a chat interface of a computing device, a user query. The functions also include determining a query embedding for the user query, wherein the query embedding is indicative of an intent of the user query. The functions further include receiving a plurality of feature vectors from a hierarchical structure of the media content, wherein the hierarchical structure is based on a characteristic of the media content, and wherein a given feature vector of the plurality of feature vectors is associated with a portion of the media content. The functions further include comparing the query embedding with the plurality of feature vectors. The functions also include identifying, based on the comparing, one or more feature vectors that are similar to the query embedding, wherein the given feature vector is associated with an identifier that identifies a node in a knowledge graph, the knowledge graph comprising nodes and edges, wherein nodes represent entities and portions of media content, and an edge between two nodes is indicative of a relationship between respective entities and portions of media content associated with the two nodes. The functions further include traversing one or more edges of the knowledge graph, wherein the traversing is based on nodes corresponding to identifiers associated with the identified one or more feature vectors. The functions further include extracting, based on the traversing, at least one relevant subgraph of the knowledge graph wherein the at least one relevant subgraph comprises content relevant to the user query. The functions also include providing the user query and the extracted at least one relevant subgraph to the generative AI model, with instructions to generate a response based on the extracted at least one relevant subgraph. The functions further include receiving a response from the generative AI model, and providing, by the chat interface and in response to the user query, the response from the generative AI model.

In a fifth aspect, a system for user interactions with media content by optimizing a retrieval of factual content for a generative artificial intelligence (AI) model is provided. The system includes means for receiving, by a chat interface of a computing device, a user query. The system also includes means for determining a query embedding for the user query, wherein the query embedding is indicative of an intent of the user query. The system also includes means for receiving a plurality of feature vectors from a hierarchical structure of the media content, wherein the hierarchical structure is based on a characteristic of the media content, and wherein a given feature vector of the plurality of feature vectors is associated with a portion of the media content. The system further includes means for comparing the query embedding with the plurality of feature vectors. The system further includes means for identifying, based on the comparing, one or more feature vectors that are similar to the query embedding, wherein the given feature vector is associated with an identifier that identifies a node in a knowledge graph, the knowledge graph comprising nodes and edges, wherein nodes represent entities and portions of media content, and an edge between two nodes is indicative of a relationship between respective entities and portions of media content associated with the two nodes. The system also includes means for traversing one or more edges of the knowledge graph, wherein the traversing is based on nodes corresponding to identifiers associated with the identified one or more feature vectors. The system further includes means for extracting, based on the traversing, at least one relevant subgraph of the knowledge graph wherein the at least one relevant subgraph comprises content relevant to the user query. The system also includes means for providing the user query and the extracted at least one relevant subgraph to the generative AI model, with instructions to generate a response based on the extracted at least one relevant subgraph. The system further includes means for receiving a response from the generative AI model, and means for providing, by the chat interface and in response to the user query, the response from the generative AI model.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 illustrates an example query processing system, in accordance with example embodiments.

FIG. 2 illustrates an example determination of a relevant subgraph, in accordance with example embodiments.

FIG. 3 illustrates an example view of the knowledge graph, in accordance with example embodiments.

FIG. 4 illustrates another example view of the knowledge graph realized as a line graph, in accordance with example embodiments.

FIG. 5A illustrates example portions of a knowledge graph, in accordance with example embodiments.

FIG. 5B illustrates example portions of a knowledge graph, in accordance with example embodiments.

FIG. 5C illustrates example portions of a knowledge graph, in accordance with example embodiments.

FIG. 5D illustrates example portions of a knowledge graph, in accordance with example embodiments.

FIG. 5E illustrates example portions of a knowledge graph, in accordance with example embodiments.

FIG. 5F illustrates example portions of a knowledge graph, in accordance with example embodiments.

FIG. 6A illustrates example portions of a knowledge graph, in accordance with example embodiments.

FIG. 6B illustrates example portions of a knowledge graph, in accordance with example embodiments.

FIG. 6C illustrates example portions of a knowledge graph, in accordance with example embodiments.

FIG. 7 illustrates an example query processing system, in accordance with example embodiments.

FIG. 8A illustrates an example view of the knowledge graph realized as a line graph, in accordance with example embodiments.

FIG. 8B illustrates an example view of the knowledge graph realized as a line graph, visualized with an extracted relevant subgraph highlighted, in accordance with example embodiments.

FIG. 8C illustrates an example view of a knowledge graph realized as a line graph, visualized with two extracted relevant subgraphs highlighted, in accordance with example embodiments.

FIG. 8D illustrates an example view of two knowledge graphs realized as line graphs, visualized with two extracted relevant subgraphs highlighted, in accordance with example embodiments.

FIG. 9 illustrates an example view of a query embedding and a plurality of feature vector embeddings realized as arrays, in accordance with example embodiments.

FIG. 10 depicts a distributed computing environment, in accordance with example embodiments.

FIG. 11 is a block diagram of an example computing device, in accordance with example embodiments.

FIG. 12 is a flowchart of a method for user interaction with media content, in accordance with example embodiments.

### DETAILED DESCRIPTION

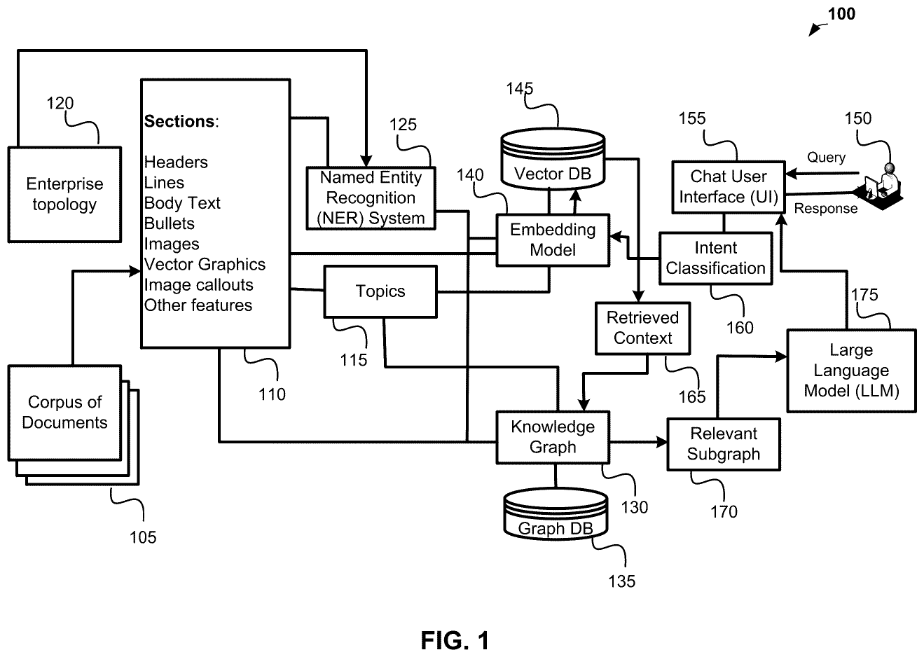

FIG. 1 illustrates an example query processing system, in accordance with example embodiments. For example, each document in a corpus of documents 105 may be pre-processed and transformed. For example, headers, lists, sections, images, call outs from the images, and so forth may be identified. In some embodiments, topic detection may be performed to identify topics 115 for each section 110, and sections with related topics and so forth.

Enterprises may have a document repository that stores the corpus of documents 105 that includes enterprise data and documents. It may be useful for enterprise users, employees, and so forth to access such documents and interact with the documents via a chat interface to obtain relevant information. Also, for example, social media platforms may have a repository that stores user posts, and users may be able to interact with such posts, and/or generate new posts.

Existing large language models (LLMs) may be provided with a document (e.g., in portable document format (PDF)) and a user may query the LLM for a response. However, another user querying the same document would need to separately upload the document in order for the LLM to process it. This is evidently inefficient and uses computational resources that are valuable, especially to an enterprise. Also, for example, the LLM would provide a response based on the uploaded document and remain oblivious to similar attributes, and/or information in related documents. Indeed, when a user uploads a first document to the LLM, the first document is retained in a temporary buffer unique to the user. The first document is not available to other users, and when the first user uploads a second document or initiates another chat session, the first document may no longer be available, and the user may need to re-upload it. Also, for example, data associated with a prior chat session related to the first document may be lost as well.

Also, for example, as noted above, when a second user wishes to interact with the first document, the second user would likely upload it separately, and a separate temporary buffer would be created for the second user. The LLM is likely to summarize, analyze, and respond to user queries in different ways, providing inconsistent responses to the same queries. In some aspects, such inconsistent responses may be minimized using prompt engineering that can predetermine a set of ranked prompts that may cause the LLM to provide similar responses. However, such an approach is feasible when the temporary buffer is shared between users.

Such problems get scaled up in an enterprise setting due to the considerable number of documents, and the large number of users querying the same or similar documents. The costs associated with such challenges can scale up quickly. Accordingly, it is desirable to have a corpus of documents 105 where enterprise data and/or social media data is stored, and multiple users may access and interact with the documents.

Generally speaking, an LLM may be provided with a knowledge graph and instructed to use data only from such a knowledge graph to provide responses to user queries.

In some embodiments, a named entity recognition (NER) system 125 may receive input from sections 110 and identify entities and relationships to generate a knowledge graph 130. In some embodiments, the enterprise may already have a customized topology 120. For example, customers may have a particular product, and a normal dictionary may not include terms associated with the product, and/or may have a different meaning than what is intended in the documents. For example, the term “civic” in HONDA CIVIC® has a particular meaning (e.g., a model of a car) that is different from the ordinary meaning of the term “civic” as used in English. Generally, the named entity recognition (NER) system 125 may not be familiar with such contextual use of terms that are not well-known. For example, although the named entity recognition (NER) system 125 is likely to recognize HONDA CIVIC® as a model of a car, it is less likely to recognize less commonly known terms, internal organizational product references, internal project names, and so forth. Accordingly, named entity recognition (NER) system 125 may receive input from customized topology 120 to generate a contextually aware knowledge graph 130. Also, for example, the knowledge graph 130 may also incorporate the hierarchical structure that is stored in sections 110. As another example, the knowledge graph 130 may incorporate the topics 115.

The named entity recognition (NER) system 125 may extract entities and relationships from the text content of all documents in the corpus of documents 105 and generate the knowledge graph 130. For example, each car model by separate car manufacturers have product manuals that describe features related to steering wheels, airbags, brakes, tires, air pressure, maintenance, and so forth. The same type of content and the same type of entities may correspond to different car manufacturers and different models by each car manufacturer. Accordingly, each such feature may be an entity and may be related across models, manufacturers etc. Over a period of time, the entities become the hubs of information as they link to relevant portions of the various documents in the corpus of documents 105. For example, the entity “steering wheel” could link to the steering wheel specifications of various car models by different manufacturers. A particular car manufacturer may have two models. The knowledge graph 130 may have a first subgraph corresponding to the first model and a second subgraph corresponding to the second model. The entity “steering wheel” is likely to appear in both subgraphs and will be linked to all entities in the two subgraphs. The knowledge graph 130 may be stored in a graph database 135. Also, for example, as the knowledge graph 130 is generated and/or updated, sections 110, topics 115, and inputs to the named entity recognition (NER) system 125 may be updated as well.

In some embodiments, the content of the documents, from sections 110, topics 115, and the output of the named entity recognition (NER) system 125 (e.g., as updated based on the knowledge graph 130) may be provided to an embedding model 140. The embedding model 140 generates feature vectors based on the content. Such feature vectors may be aligned with the contents of the knowledge graph 130. Also, for example, the feature vectors may be embedded in an embedding space where the distance between two feature vectors may correspond to a weight of a link between entities in the knowledge graph 130. For example, two entities that are strongly linked in the knowledge graph 130 may be embedded closer together, and two entities that are weakly linked in the knowledge graph 130 may be embedded further apart. The feature vectors generated by the embedding model 140 may be stored in the vector database 145.

In some embodiments, the weight of a link (or edge) between entities in a knowledge graph quantifies the strength, relevance, or confidence of the relationship between them. This numerical value allows the graph to represent more than just the existence of a connection; it captures the nuances of that connection. A higher weight indicates a stronger link, while a lower weight indicates a weaker link. This is used in graph embedding models to represent relationships in a multi-dimensional vector space.

The weight of a link can be determined by several factors, depending on the nature of the data and the purpose of the knowledge graph. Frequency or Co-occurrence is a method to assign a higher weight to entities that appear together more frequently. For example, in a knowledge graph built from a document corpus, the link between “Apple” (the company) and “iPhone” would have a high weight because they co-occur often. The degree of semantic similarity between two entities can be used as a link weight. This is particularly relevant when the entities are related conceptually but may not co-occur often in the source data. The link weight can be based on how topically relevant the two entities are to each other. This can be calculated using techniques like Latent Dirichlet Allocation (LDA) to determine shared topics. In a knowledge graph built for a recommendation system, the link weight may be influenced by user behavior. For instance, if many users are satisfied with a response to a user query after viewing the response, the link between the nodes in the relevant subgraph would have a high weight. In an automatically generated knowledge graph, a machine learning model can assign a confidence score to each relationship it identifies. This score acts as the link weight, reflecting the model's certainty that the relationship is valid.

A user 150 may interact with the corpus of documents 105 via a chat user interface (UI) 155. For example, the user 150 may enter a query in chat UI 155. The query may be in different modalities (e.g., text, speech, haptic, image, video, etc.) and may be in different languages. The type of query may generally depend on the functionalities provided by LLM 175. In some embodiments, when the query is received at the chat UI 155, an intent classification 160 may be performed to extract user intent from the query. The query may be provided to the embedding model 140 to generate a query feature vector for the query. The query feature vector may be compared to the feature vectors stored in vector database 145 to identify one or more similar feature vectors.

The term LLM as used herein may include large language models (LLMs), large multimodal models (LMM), etc. that can process and generate content in multiple modalities, such as text, audio, image, video, and other types of data such as sensory data, multilingual models that can take input and generate output in multiple languages, etc. LLM 175 need not be trained on task-specific training data and can perform multiple tasks.

As previously described, the feature vectors stored in vector database 145 may generally correspond to portions of the knowledge graph 130. Accordingly, when the one or more feature vectors similar to the query feature vector are identified, these are provided to the received context 165. Subsequently, the one or more feature vectors may be used to identify entities and relationships in the knowledge graph 130. For example, a relevant subgraph 170 of the knowledge graph 130 may be identified, where the relevant subgraph 170 includes information from the corpus of documents 105 that are pertinent to responding to the user query.

Generally speaking, the knowledge graph 130 for a given enterprise may be large. Accordingly, providing the entire knowledge graph 130 to the LLM 175 would likely result in an unnecessary use of computational resources. Also, for example, providing the entire knowledge graph 130 to the LLM 175 may not elicit an accurate and/or reliable response to the user query. As another challenge, the larger the amount of information provided to the LLM 175, the longer LLM 175 is likely to take to process the information and output a response. Given the volume of information and the likely volume of simultaneous queries to be received from different users, providing the entire knowledge graph 130 to the LLM 175 is not a practical solution. Also, for example, with several documents having overlapping information (e.g., steering wheels), experimental results indicate that the LLM 175 is likely to generalize from the information in different overlapping entities to generate a response that is unlikely to be accurate and may also not be relevant to the query. Accordingly, the identifying of the relevant subgraph 170 that includes information from the corpus of documents 105 that is pertinent to responding to the user query is a significant technical improvement that solves these technical challenges. Such an approach allows for considerable savings in terms of computational resources (processor time, memory, data traffic, tokens, etc.), decreases response time, and increases accuracy and relevance of the response to the query.

The vector database 145 allows for an accurate embedding of the query. In some embodiments, internal prompt engineering may be used to identify nodes of the relevant subgraph 170 of the knowledge graph 130. For example, a prompt to LLM 175 may include an introductory padding, a summary padding, and so forth. However, a sizable portion of the prompt is the relevant subgraph 170 of the knowledge graph 130. This enables a strong limit on potential hallucinations by LLM 175. The data for the LLM 175 is specifically limited to the relevant subgraph 170 that represents the relevant portion of the enterprise content. This prevents the LLM 175 from obtaining information for a response from content other than what is represented in the relevant subgraph 170.

In generating the knowledge graph 130, subject matter experts may initially create labeled training data that includes documents, associated entities, and interrelationships between the entities. In some embodiments, supervised or semi-supervised learning may be used to train a machine learning model to generate the knowledge graph from a collection of documents. Reinforcement learning may be used where subject matter experts indicate positive reinforcement by verifying that certain entities and relationships are correct and indicate negative reinforcement by removing certain entities and relationships as being incorrect. For example, a graph interface may allow a subject matter expert to review and edit the knowledge graph.

As indicated, the knowledge graph 130 may include nodes and edges that connect such nodes. The nodes may be an entity node representing an entity or a text node representing text. The text nodes may be related based on a hierarchical structure of the document. For example, the document may include a chapter titled “steering wheel.” Accordingly, a first text node may correspond to “Chapter 1—Steering Wheel,” and a second text node may correspond to a description such as “The steering wheel is a . . . ” Also, for example, an entity node may represent “Steering Wheel.”

A first edge may link the first text node to the entity node indicating the relationship between these nodes. Likewise, a second edge may link the second text node to the entity node indicating the relationship between these nodes. These edges/relationships may be used to determine entity weights. Also, for example, a third edge may link the first text node to the second text node indicating the hierarchy between these nodes in the hierarchical structure of the document.

The knowledge graph 130 may include entity weights associated with the entities. The entity weight for a particular entity indicates the entity's relevance in the text, with higher weights indicating stronger relationships. This helps highlight which entities are most significant to understanding the context within the document. For example, a general noun may be detected in the documents and may not be identified as an entity. Accordingly, the general noun may be persisted in the knowledge graph 130 as a general noun and may be associated with a weight of “0.” In some embodiments, the entity weight may be determined based on a term frequency and a co-occurrence frequency. For example, the entity weight may be based on an entity frequency in the text indicating how often the entity appears in the specific section of the document. As another example, the entity weight may be determined based on a length of the text indicating an overall size of the text segment, adjusted for the entity's occurrence. Also, for example, the entity weight may be determined based on an entity frequency in the entire document and/or a corpus of documents indicating how often the entity appears across the full document. One or more of the above weight determinations may be combined to obtain the entity weight. By comparing such factors, a determination may be made as to how much an entity stands out in a particular text segment. Additionally, logarithms may be used to compress a scale of such comparisons, ensuring that remarkably high or very low frequencies do not dominate the weight determination. Such a logarithmic adjustment can ensure a more balanced evaluation of entity importance.

In identifying the relevant subgraph 170, one approach may be to include entities that have an entity weight that exceeds an entity threshold. For example, a graph traversal algorithm to identify the relevant subgraph 170 may begin at a node identified by the one or more feature vectors that are identified to be similar to the query feature vector. Starting from such an initial node, the edges that connect to nodes that have an entity weight greater than an entity threshold (e.g., nodes that are deemed sufficiently relevant) may be traversed, and such nodes and edges may be included in the relevant subgraph 170. The knowledge graph 130 may be traversed until all next entities have entity weights below the entity threshold.

Such an approach is a method for pruning a knowledge graph to extract a relevant subgraph for a user query. It uses a filtering mechanism based on entity weights and a threshold to manage the scope of the graph traversal. An entity weight is a numerical value assigned to each node (entity) in the knowledge graph. This weight quantifies the perceived importance, relevance, or salience of that entity within the entire graph or within a specific context. The weight can be calculated in numerous ways. For example, the entity weight may be based on frequency which is a number of times the entity appears in the source media content. A measure of how important an entity is to the overall network structure may be used to determine an entity weight. For example, an entity with many incoming and outgoing links (high degree centrality) might have a higher weight. A value from a language model that indicates the relevance of the entity to a specific topic or theme may also be used to determine an entity weight.

The entity threshold may be a predefined value. Any entity with a weight below this threshold may be considered insufficiently relevant and may not be included in the traversal. This acts as a filter, preventing the graph traversal from expanding into less-important or tangentially related areas. Generally, the entity threshold may depend on several factors, including, for example, a type of query, an intent of the query, a location of the entity in the knowledge graph 130, a type of user entering the query (e.g., user access permissions to relevant content within the enterprise), and so forth. For example, the knowledge graph 130 may be associated with layers of access restrictions based on user permissions. Certain users may not have access to certain portions of the knowledge subgraph 130 (e.g., highly restricted information), and the entity weights and entity threshold may be based on the universe of content that may be accessible to a particular user. In some embodiments, different portions of the knowledge graph may be associated with different entity thresholds.

The graph traversal algorithm may be a focused search or a “breadth-first search” with a relevance filter. The process begins with one or more nodes that are directly identified as relevant to the user query. This initial relevance is determined by comparing the user's query embedding to the feature vectors associated with the knowledge graph nodes. For example, if the query is “What color is the car?”, the node for “car” would be the starting point. From the starting node, the algorithm examines its connected edges. It only traverses to the next entity if that entity's weight exceeds the entity threshold. This is a significant pruning step. Nodes with weights below the threshold are ignored, and their branches are not explored. The graph traversal continues, adding the nodes and edges that meet the weight criterion to the relevant subgraph. This creates a smaller, more manageable subset of the knowledge graph that is highly relevant to the query. The traversal terminates when all potential next entities have weights that are below the threshold. This ensures the search process is not lost in irrelevant data, providing a clean and focused subgraph for the LLM. This approach offers a computationally efficient way to extract relevant information. Instead of traversing the entire graph (which can be massive), the traversal is limited to a small, highly relevant portion. This reduces the time and resources required to prepare the context for the LLM, leading to faster response times.

In some embodiments, the knowledge graph 130 may be implemented as a line graph where the nodes represent entities and text portions appearing in the corpus of documents, and the edge between two nodes is indicative of a relationship between the text portions and entities. The user query is converted into a query embedding and compared to feature vectors in the vector database 145. The feature vectors are indexed with the relevant portions of the documents as well as correspond to the nodes and relationships in the knowledge graph 130. Accordingly, identifying the one or more feature vectors similar to the query embedding or query feature vector associates the portions of the documents and the knowledge subgraph 130 to the query. The knowledge subgraph 130 may be generated by use of the named entity recognition (NER) system 125, parts-of-speech (POS) identifier system, and so forth.

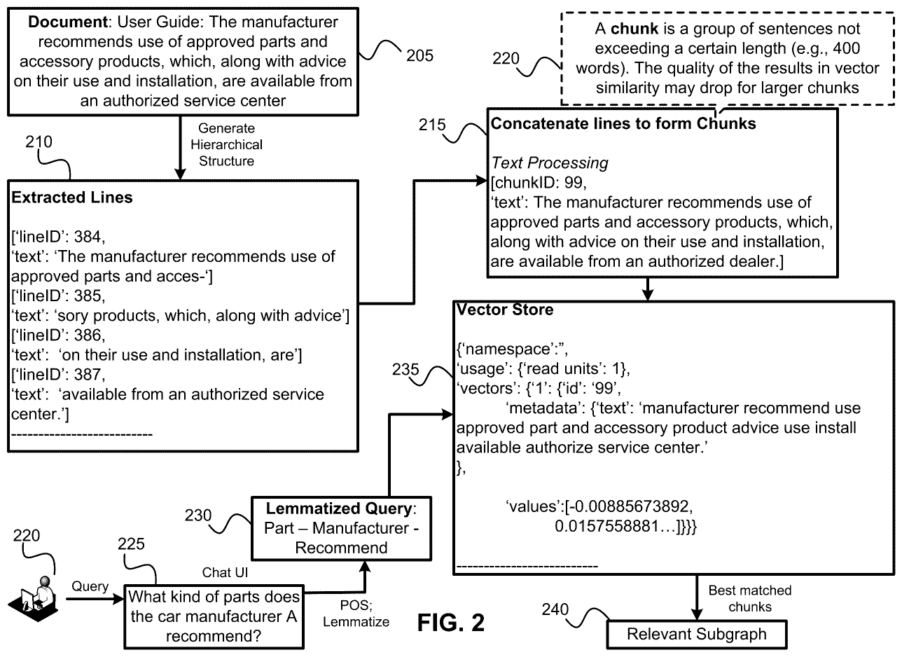

FIG. 2 illustrates an example determination of a relevant subgraph, in accordance with example embodiments. A document 205 may correspond to a user guide for a vehicle manufacturer. After performing the document pre-processing to identify sections etc., to determine extracted lines 210. In some embodiments, extracted lines 210 may include tuples of different line segments identified by a line number. Groups of such sentences from extracted lines 210 may be concatenated to form chunks 215. As indicated, a chunk is a group of lines or sentences so that the total number of words in the chunk does not exceed a chunk threshold (e.g., 400 words). The chunk threshold is significant as the quality of results in a vector similarity match may be significantly impaired as the size of a chunk increases.

The chunks 215 are embedded in a vector store 235. When a user 200 enters a query 225 in a chat UI, the query is analyzed based on a POS system and also lemmatized. A lemmatized query 230 is generated and a query embedding is determined. For example, when a user enters a query in a chat UI, it undergoes a series of natural language processing (NLP) steps to be transformed into a format that can be effectively processed by a computer. This process involves Part-of-Speech (POS) tagging, lemmatization, and generating a query embedding. POS tagging is the process of assigning a grammatical category, or “part of speech,” to each word in the query. This system helps the computer understand the function of each word in the sentence. Common POS tags include a noun such as a person, place, or thing (e.g., “cat,” “store”), a verb such as an action or state of being (e.g., “run,” “is”), an adjective such as a word that describes a noun (e.g., “blue,” “happy”), an adverb such as a word that describes a verb, adjective, or another adverb (e.g., “quickly,” “very”), a pronoun such as a word that replaces a noun (e.g., “he,” “it”), and a preposition such as a word that links nouns, pronouns, and phrases to other words in a sentence (e.g., “in,” “on”). POS tagging is typically performed using machine learning models trained on large, annotated text corpora (like the Penn Treebank). These models predict the most likely tag for each word based on its context within the sentence.

Lemmatization is the process of converting a word to its base or dictionary form, known as its lemma. Unlike stemming, which simply chops off the end of a word, lemmatization uses a vocabulary and morphological analysis to ensure the resulting lemma is a valid word. For example, “running,” “ran,” and “runs” become the lemma “run.” As another example, “better” and “best” become the lemma “good.” Also, for example, “geese” becomes “goose.” A lemmatized query may be generated by applying this process to every word in the original query. For instance, the query “How are the birds flying?” would be lemmatized to “How be the bird fly?” This standardization is used for tasks like information retrieval, as it ensures that queries and documents with different word forms of the same concept are matched correctly.

A query embedding is a numerical representation of the query in a high-dimensional vector space. The goal is to capture the semantic meaning of the query so that similar queries have similar vector (feature) representations. Tokenization may be performed to break down the lemmatized query into individual words or sub-words (tokens). Lookup and/or encoding may be performed where each token is converted into a vector. This can be done using pre-trained language models like Word2Vec, GloVe, or BERT. These models have learned to represent words as dense vectors where the distance and direction between vectors encode semantic relationships. For example, in a good embedding space, the vector for “king” minus “man” plus “woman” should be close to the vector for “queen.” The vectors of all tokens in the query may be aggregated into a single, comprehensive vector. This can be performed by averaging the token vectors or by using a more sophisticated method, like passing the sequence of token vectors through a neural network (e.g., a transformer model like BERT or a recurrent neural network).

The resulting query embedding may be a dense vector (e.g., with 768 or 1024 dimensions) that numerically represents the entire meaning of the user query. This query embedding can then be used to perform tasks like semantic search, where the system finds documents or responses with the closest vector similarity, regardless of the exact words used.

For example, the query embedding may be matched against the embeddings in vector store 235, and the most similar chunks (e.g., corresponding to the one or more feature vectors that are most similar to the query embedding) are identified. These one or more feature vectors are used to identify a relevant subgraph 240 of the knowledge graph.

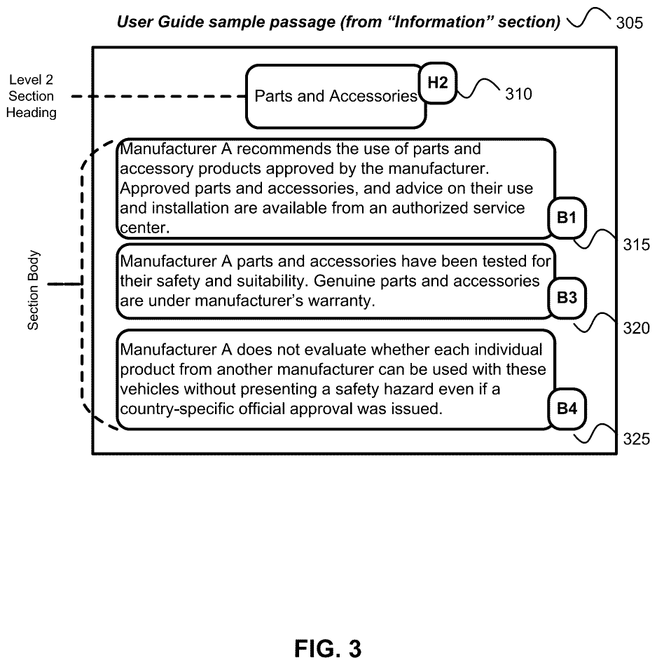

FIG. 3 illustrates an example view of the knowledge graph, in accordance with example embodiments. A sample passage 305 from the “Information” section of a user guide is shown. This corresponds to heading level one and then under that is heading level two “H2” 310 that corresponds to “parts and accessories.” The text within H2 310 may be separated into chunks such as B1 315, B3 320, B4 325, and so forth.

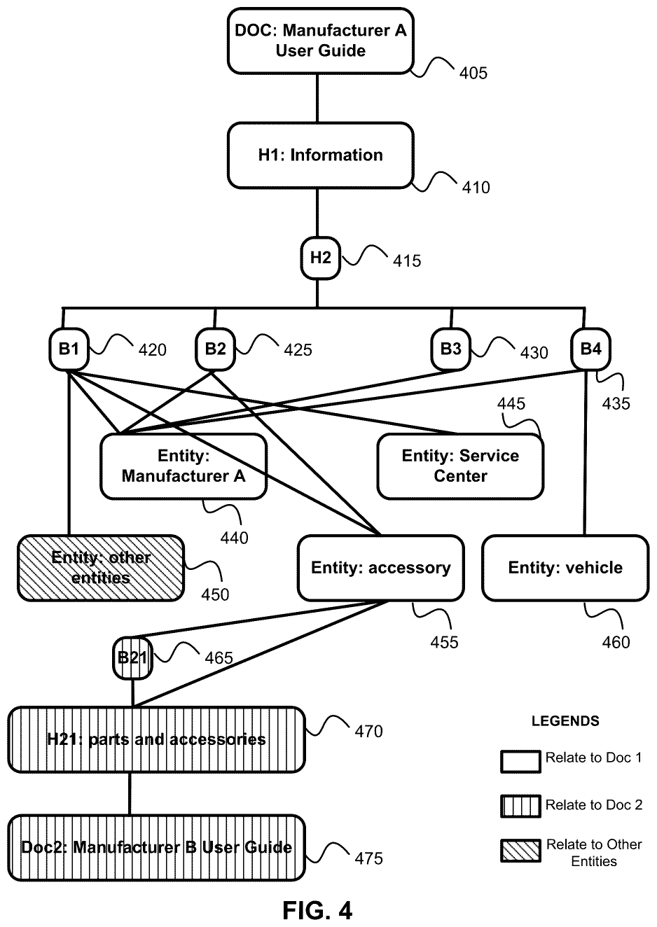

FIG. 4 illustrates another example view of the knowledge graph realized as a line graph, in accordance with example embodiments. As indicated, the guide 405 may have a top level with a first header H1 410 for “Information.” This may be followed by a second header level H2 415. H2 415 may include four sublevels of chunks, B1 420, B2 425, B3 430, B4 435. Each of these chunks may be connected to one or more entities. For example, chunk B1 420 may be linked to a first entity 440 corresponding to “Manufacturer A,” a second entity 445 corresponding to “Service Center,” a third entity 455 corresponding to “accessory,” and a fourth entity 450 representing one or more other entities. Similarly, chunk B2 425 may be linked to first entity 440 corresponding to “Manufacturer A,” and third entity 455 corresponding to “accessory.” Chunk B3 430 may be linked to first entity 440 corresponding to “Manufacturer A.” Chunk B4 435 may be linked to first entity 440 corresponding to “Manufacturer A,” and a fifth entity 460 corresponding to “vehicle.”

Also, for example, third entity 455 corresponding to “accessory” may be linked to chunk B 21 465 corresponding to a different document (other than Manufacturer A User Guide 405), and another heading level H21 470. In turn, H21 470 may be linked to Doc 2 475 corresponding to “Manufacturer B User Guide.”

Referring to FIG. 2, the query 225 corresponds to “parts.” Accordingly, the query embedding would be associated with a feature vector with chunk ‘id’: 99 as indicated by the vector store 235. This feature vector may be associated with chunk B1 420 in FIG. 4. Once the one or more similar feature vectors are identified, their chunk identifiers may be used to locate the corresponding nodes on the knowledge graph. Accordingly, the corresponding node B1 420 may be located in the knowledge graph. Generally, in identifying the relevant subgraph, one approach may be to move one level up from the identified node to a parent of the identified node and initiate the graph traversal algorithm (traversing over edges to reach a next node with an entity weight greater than an entity threshold and not traversing over edges to reach a next node with an entity weight that does not exceed the entity threshold). Accordingly, the graph traversal algorithm may move from B1 420 to H2 415, as based on the hierarchy, it is likely that content represented in H2 415 is relevant to the query. The graph traversal algorithm selects B1 420, B2 425, and B3 430. As the query relates to Manufacturer A, a choice is made not to select node B21 465 for inclusion in the relevant subgraph, as node B21 465 is associated with content related to Manufacturer B.

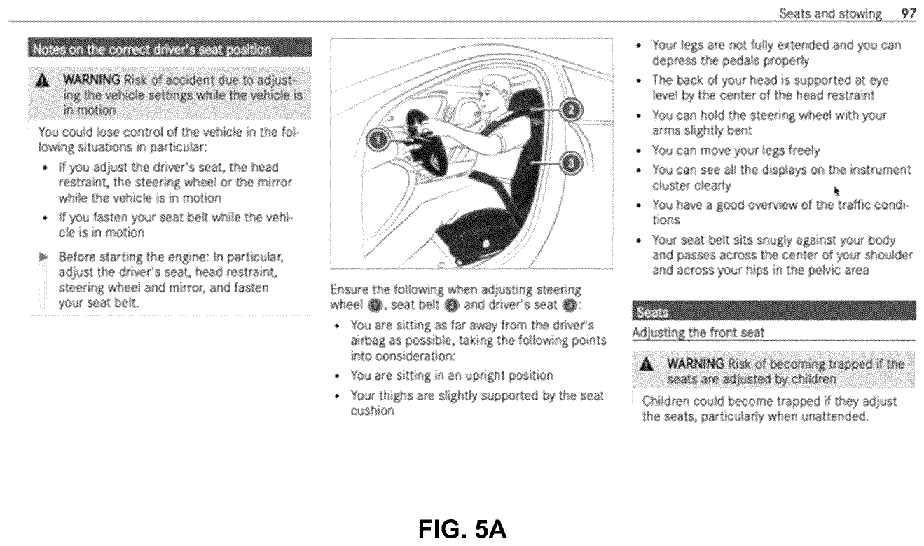

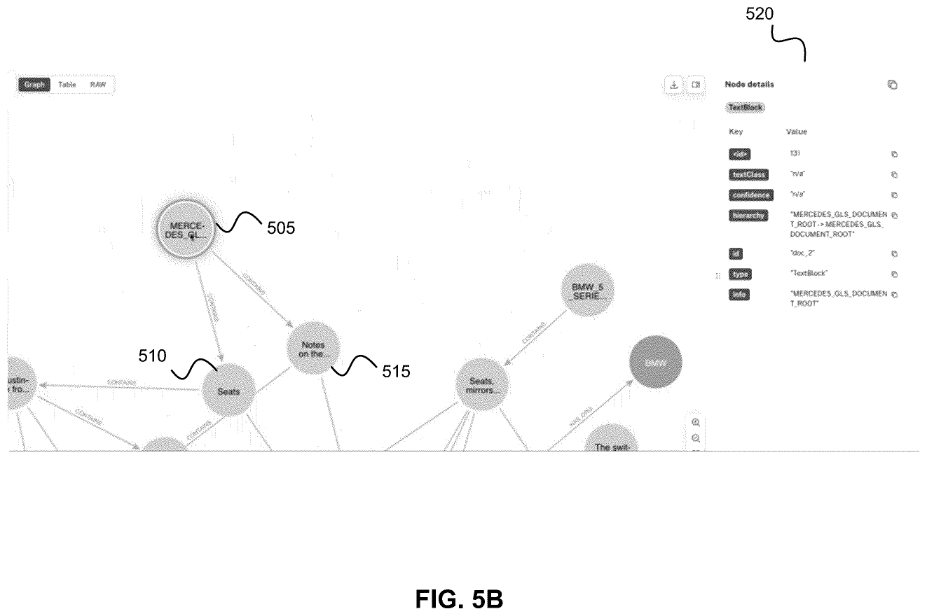

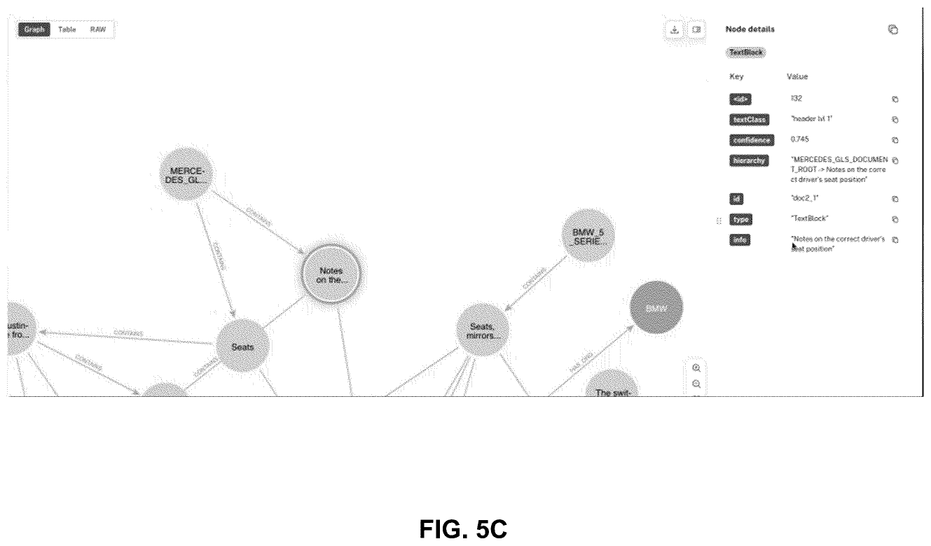

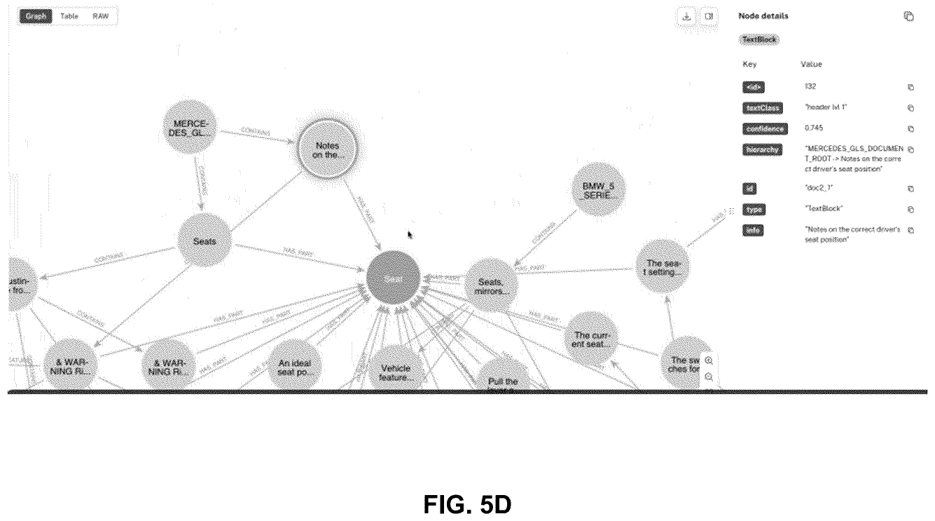

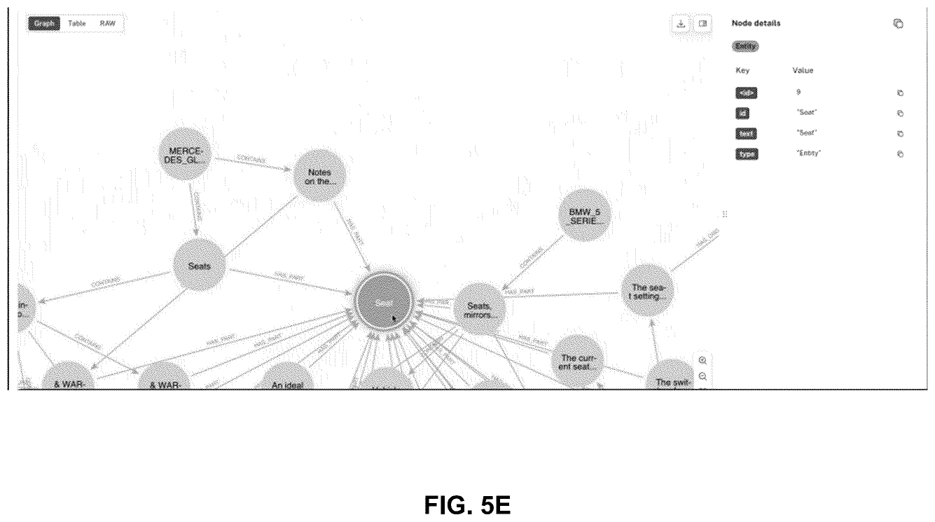

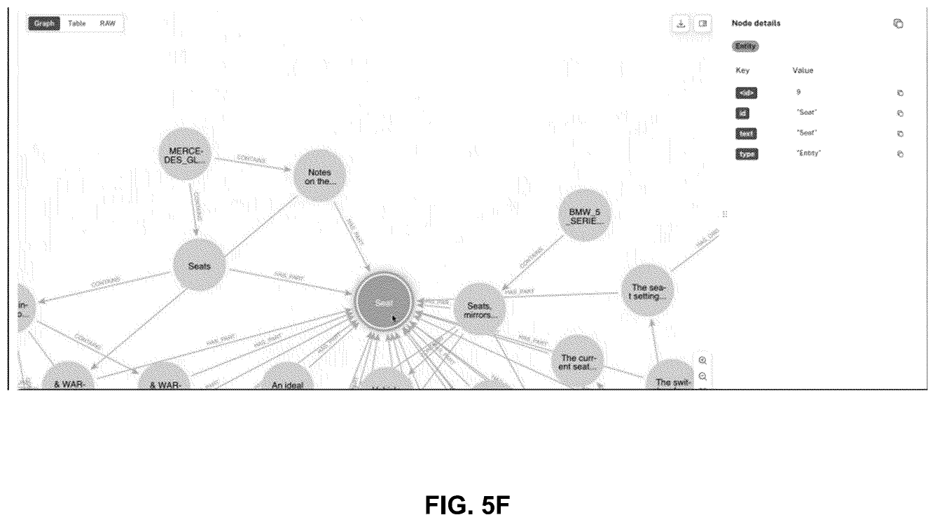

FIGS. 5A-5F illustrate example portions of a knowledge graph, in accordance with example embodiments. FIG. 5A illustrates a portion of a document that describes “seats and stowing.” FIG. 5B illustrates the corresponding portion of the knowledge graph. For example, node 505 represents a header at level one (as illustrated in FIGS. 3 and 4). Each node is associated with a node ID and in the hierarchical context, the node 505 is linked to a child node “seats” 510, and another child node “notes on correct seat position” 515. A user interface 520 is displayed that provides the properties of each selectable node in the knowledge graph. FIGS. 5C-5F illustrate additional instances of the knowledge graph with various entities and relationships.

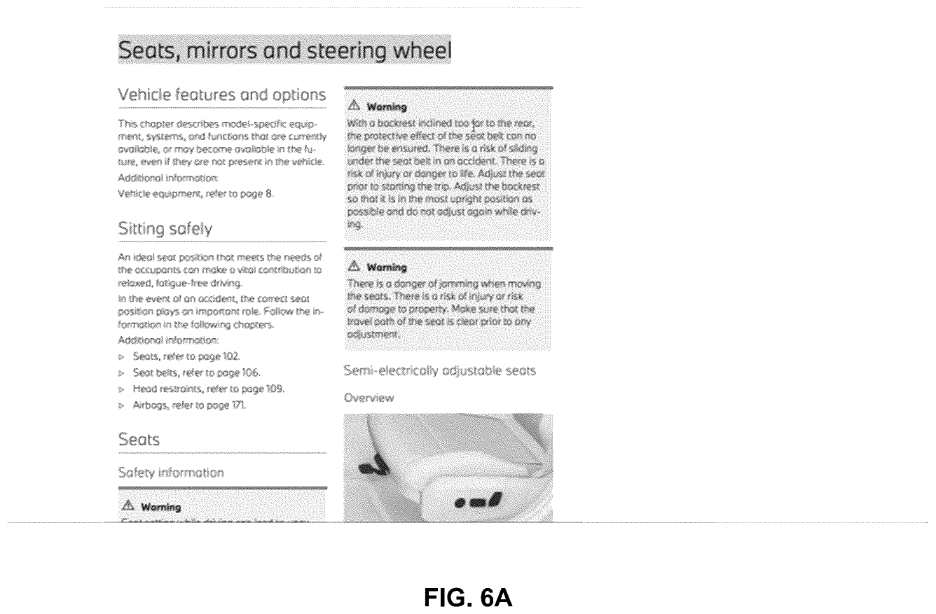

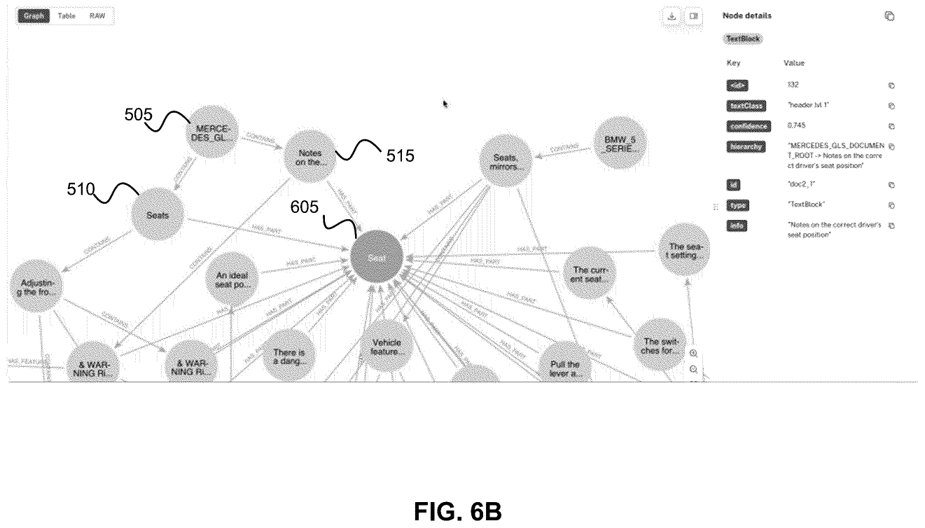

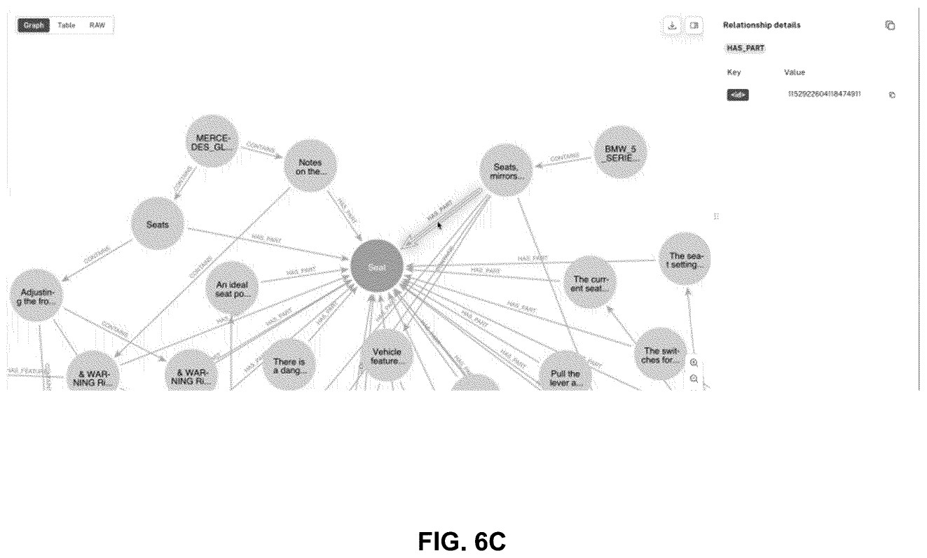

FIGS. 6A-6C illustrate example portions of a knowledge graph, in accordance with example embodiments. FIG. 6A illustrates a portion of a document that describes “seats mirrors and steering wheel.” FIG. 6B illustrates the corresponding portion of the knowledge graph. For example, node 505, child node “seats” 510, and another child node “notes on correct seat position” 515 from FIG. 5B are shown for context. Additionally, a new node “Seats” 605 is illustrated.

Although document processing and the related hierarchical structure and knowledge graphs have been described in detail, these technologies can be applied to other types of media content.

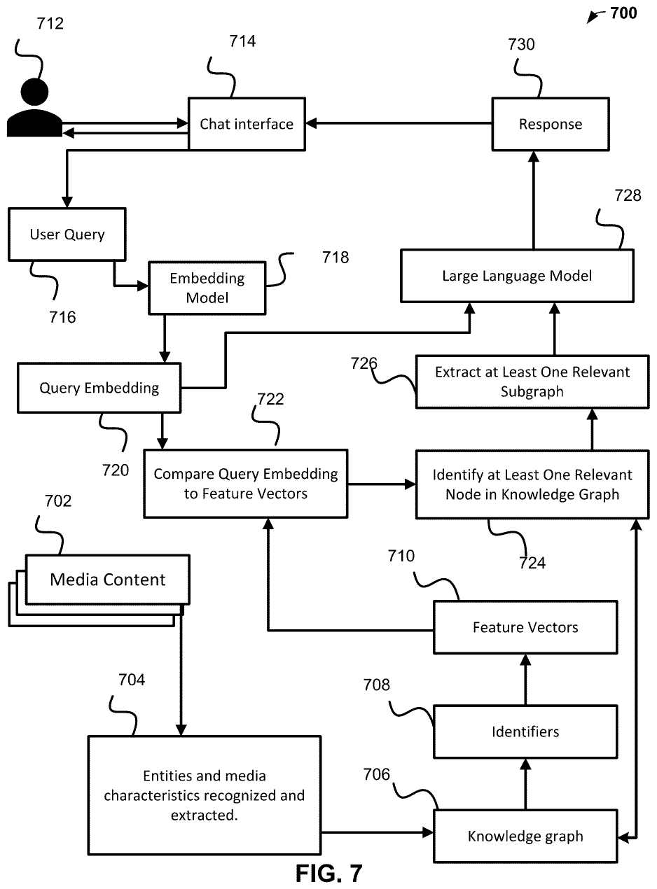

FIG. 7 illustrates an example query processing system, in accordance with example embodiments. In some embodiments, a piece of media content 702 may be processed by an entity recognition system 704. In some embodiments, the media content may comprise one or more of a video, an audio, a document, a presentation, an image, and so forth. In some embodiments, characteristics and entities of the media content are extracted. For example, motion features of the video, chunks of the transcript of the audio, colors of the video, a texture of the video, a light intensity of the video, a musical content of the video, and so forth may all be included as characteristics. In some embodiments, entities may include terms relevant to the media, such as names, individuals appearing in videos, objects in videos, specific voices identified in an audio recording, and so forth.

A hierarchical structure for media content generally organizes it into a nested, tree-like system based on a specific characteristic. This structure breaks down large pieces of media into smaller, more manageable parts, making it easier to navigate and understand. hierarchical structure may be defined by a top-down arrangement, where the root is the entire media item and branches lead to smaller segments, or nodes. Each node can have its own sub-nodes, creating multiple levels of hierarchy. The characteristic used to build this hierarchy can be anything from time to topic to semantic meaning.

For example, the media content may be video, and the hierarchical structure may be based on time or semantic content. For example, a movie can be broken down by time-based hierarchy. This can be a linear hierarchy where a first level includes the entire movie, a second level includes acts or chapters, a third level includes scenes within each act or chapter, and a fourth level includes individual shots within a scene. Also, for example, the movie can be broken down by semantic-based hierarchy. This can include a first level comprising the entire movie (e.g., Lord of the Rings), a second level including thematic arcs (e.g., “The Fellowship's Journey,” “The War for Middle-earth”), and a third level including specific events or subplots within those arcs (e.g., “The Mines of Moria” within “The Fellowship's Journey”).

As another example, the media content may be audio, and the hierarchical structure may be topic-based or musical-based. Audio content, like a podcast or a musical album, can be structured based on topic, speaker, or musical composition. A topic-based hierarchy for a podcast may include a first level including a full podcast episode, a second level comprising primary discussion topics (e.g., “Introduction,” “Topic A: AI Ethics,” “Topic B: Space Exploration,” “Conclusion”), and a third level comprising sub-points or specific examples within each topic. A musical-based hierarchy for a symphony can include a first level that includes the entire symphony, a second level comprising individual movements (e.g., Allegro, Adagio), and a third level comprising thematic sections within each movement (e.g., Exposition, Development, Recapitulation).

Also, for example, the media content may be a corpus of documents, and the hierarchical structure may be topic-based or character-based. A topic-based hierarchy for a technical manual may include a first level including the entire manual, a second level including major sections (e.g., “Installation,” “Operation,” “Troubleshooting”), and a third level including sub-sections or chapters within each major section (e.g., “Hardware Requirements,” “Software Setup” within “Installation”). A character-based hierarchy for a book can include a first level that includes the entire novel, a second level that includes major characters or groups, and a third level comprising chapters dedicated to or primarily featuring that character's journey.

In some embodiments, a hierarchical structure for documents can also be based on technologies described in U.S. patent application Ser. No. 19/174,086 titled “Systems and Methods for Transforming Documents to a Structured Searchable and Linked Format,” filed on Apr. 9, 2025, which claims priority to U.S. Provisional Application No. 63/631,818 filed Apr. 9, 2024, and the contents of both are incorporated herein in their entirety. For example, the hierarchical structure for document may be based on one or more attributes of the document, wherein the one or more attributes comprise a font detail or a vector graphics, or both. The font detail can also include at least one of: a type of font, a font size, or a font color. Also, for example, the vector graphics may be detected by detecting a vector graphic intersecting a bounding box of an image in the initial document. The one or more attributes may include one or more structural attributes comprising at least one of: a page attribute, a type of numbering, a line spacing, a callout, a hyperlink, header information, footer information, section information, column structure, page layout, a paragraph layout, position of a text in a line, or part-of-speech (POS) information. The one or more attributes may include one or more content attributes comprising at least one of: image content, video content, textual content, or audio content.

Building a hierarchical structure for audio or video content involves analyzing the video's characteristics using various computational methods. These characteristics, or features, are extracted from the audio or video stream to create a multi-layered representation that is more detailed and useful than a simple linear timeline. For example, inter-frame motion features may include the movement of objects and cameras between consecutive frames in a video. This is a concept in video compression, where codecs like H.264 and HEVC only store the “delta” or changes between frames (P-frames and B-frames) instead of a full image for every frame. Motion vectors are 2D vectors that represent the displacement of a block of pixels from a reference frame to the current frame. Optical flow is a more dense motion representation that calculates the apparent motion of every pixel in the image sequence. Motion analysis can analyze these vectors to help identify scene changes, object tracking, and camera movements (e.g., panning, zooming). For example, a sharp increase in motion vectors might indicate a quick action scene or a sudden camera pan, which could be a key point for a new branch in the hierarchy.

A video's audio track can be analyzed to generate text and identify distinct sound events. Automated speech recognition (ASR) technology (e.g., Speech-to-Text (STT)) can be used to convert spoken words into a text transcript. This is a feature for creating a topic-based hierarchy. For example, a documentary could be organized by the main subjects discussed in the transcript. Speaker diarization can be used in audio or video to identify who is speaking and when, segmenting the audio by speaker. This allows for a hierarchy based on speakers (e.g., a meeting video organized by “CEO's Speech,” “CFO's Report,” etc.). Audio event detection can be used in audio or video to identify non-speech sounds like music, applause, or silence. This can be used to segment the video and create a hierarchy based on sound events (e.g., “Intro Music,” “Audience Applause”).

Every frame in a video or segments of audio may be associated with a timestamp, representing its position in the video or audio timeline. This is another way to create a hierarchy based on time. For instance, an audio or video could be divided into 5-minute segments, each with a corresponding timestamp. Individual frames, or groups of frames, of a video can be analyzed for their visual properties.

Color analysis can involve extracting color histograms or dominant color palettes from frames. For example, a color-based hierarchy could segment a film by its color grading, with a “warm” scene transitioning into a “cool” scene. This is often used in film analysis to capture mood and tone. The light intensity level measures an average brightness of a frame. Changes in light levels can indicate transitions, such as moving from a brightly lit outdoor scene to a dimly lit indoor one, which could define a new hierarchical node. Texture analysis involves algorithms like Gabor filters or Local Binary Patterns (LBP) to describe the visual texture (e.g., rough, smooth, patterned) of a region. This can be used to segment scenes with distinct textures, such as a close-up on a character's face versus a wide shot of a textured landscape.

In some embodiments, entities and musical content may be higher-level, more abstract features that require advanced computational analysis. For example, entity recognition uses computer vision models to identify and categorize objects, people, and places appearing in the video. For example, a sports video could have a hierarchy based on the players, teams, and stadium that appear in different segments. Facial recognition and object detection are some technologies that may be used here. Musical content involves analyzing an audio track for musical characteristics like tempo, key, genre, and emotional valence. This can be used to create a hierarchy for audio, music videos or films where the narrative follows the emotional arc of the music. For instance, a video or audio segment could be tagged with “upbeat music” or “dramatic score.”

Generating a hierarchy for audio can be based on the pitch or tone of an audio track and involve a process called pitch detection. This is distinct from simply measuring frequency, as pitch is the perceived fundamental frequency by a human ear, which may not always be the loudest or lowest frequency present in the sound. For example, pitch detection involves identifying the fundamental frequency, which is the lowest frequency of a periodic waveform. For complex sounds like musical notes or speech, the perceived pitch is often this fundamental frequency, even if it is not the most prominent.

Some techniques for pitch detection include autocorrelation that compares an audio signal with a time-shifted version of itself to find repeating patterns. A strong correlation at a certain delay suggests a period, and the reciprocal of this period is the fundamental frequency. A Fast Fourier Transform (FFT) can provide a spectrum of frequencies present. However, a simple FFT peak may not correspond to the perceived pitch. More sophisticated algorithms use the FFT to analyze the harmonics (integer multiples of the fundamental frequency) to find the fundamental frequency. This is used for recognizing a musical note even if the fundamental frequency is “missing” or quiet. A YIN Algorithm is another robust pitch detection algorithm that uses a difference function to find the fundamental frequency. It is known for being accurate with both musical and speech signals.

Besides the methods already discussed, there are additional and/or alternative ways to create a hierarchical structure for audio, video, and documents. For example, emotion and/or sentiment may be used. In audio or video content, the audio track may be analyzed for emotional content. This can be done through vocal prosody (e.g., pitch, volume, speed) and lexical analysis of the transcript. A video hierarchy could be structured by emotional arcs, such as “rising tension,” “climax,” and “resolution.” For documents, sentiment analysis can classify text sections as positive, negative, or neutral. A hierarchy could be built around these sentiments, grouping positive feedback, customer complaints, or objective reports together.

NER is a technique that identifies and classifies key entities mentioned in the media content, such as people, organizations, locations, dates, and products. A video or document hierarchy could have a top-level node for a person, with sub-nodes for specific events or discussions involving them. For example, in a news video, you could have a branch for “The President,” with sub-branches for “Speech on the Economy,” “Visit to a Hospital,” and “Foreign Policy Statement.”

A beat and/or rhythm analysis may be used for audio content. For musical content, a hierarchy can be based on the rhythm and tempo. An algorithm can detect the beat and downbeat of a song, segmenting it into logical sections like an “intro,” “verse,” “chorus,” and “bridge.” This is particularly useful for DJing software or music-based video editors.

Cross-modal analysis may be used for audio or video content. This method leverages the relationship between different media types to build a more robust hierarchy. For example, a system could correlate changes in camera angles (a video characteristic) with changes in speaker identity (an audio characteristic) to create a scene boundary. This can be used to automatically summarize meeting recordings or educational lectures.

For a document, a hierarchical structure based on its characteristics is a way to organize content from a high level (the whole document) down to a granular level (pages, sections, and individual elements). This makes it easier to navigate, search, and understand the document's content. One physical characteristic of a document is its division into pages. A hierarchy can be built directly on this, with each page being a node. For example, a legal brief might be organized by page number, allowing for quick reference to specific content locations. Headings (and subheadings) are a primary organizational tool. They indicate the start of new topics or subtopics, forming a natural hierarchical structure. This is similar to a table of contents. A top-level heading, such as “Chapter 1,” can be a parent node, with subsequent subheadings like “Section 1.1” and “Section 1.2” as child nodes. A section is a logical grouping of content, often defined by its heading. A section can contain text, images, and other sub-sections. This characteristic allows for a hierarchy that reflects the document's logical flow and content grouping, such as organizing a research paper by “Introduction,” “Methodology,” and “Results.”

Content-based characteristics relate to the specific information and elements within the document. For example, entities are named items of interest, such as people, organizations, locations, or products. Using NER, a system can identify all entities in a document and create a hierarchy based on them. For example, a document hierarchy could have a node for “Marcus Aurelius,” with sub-nodes for every paragraph or section where he is mentioned. Font characteristics, such as font style, size, and weight (e.g., bold, italic), can be used to infer the semantic role of text. For instance, headings might be in a larger, bold font, while citations might be in a smaller, italic font. A hierarchy could be created based on these visual cues, grouping all text with a specific font style. An image or diagram can be treated as a distinct node in a document hierarchy. It is often linked to the section or page where it appears. The image itself can have its own characteristics, such as an image caption, which can be used to understand its content and generate a more detailed hierarchy. This allows a user to search for all images related to a specific topic within a document.

Feature vectors can be extracted from audio, video, and document hierarchies by capturing a condensed, numerical representation of the content at each level of the hierarchy. This process transforms complex, raw data into a structured format that is easy for machine learning algorithms to process. This can involve combining features from different hierarchical levels to create a comprehensive vector.

For audio, a hierarchy might be based on time (e.g., full track, song, stanza, beat). To create a feature vector, a multi-level extraction approach may be used. Low-level Features (Individual Audio Segments/Frames) can be extracted at a granular level, from small audio frames (e.g., 20-40 milliseconds). Common features include Mel-Frequency Cepstral Coefficients (MFCCs) which is a standard for speech and music analysis, MFCCs represent the short-term power spectrum of a sound, the fundamental frequency (pitch) and perceived volume (loudness) of the signal. Also, spectral features can be used to measure a spectral centroid (the “brightness” of a sound), spectral flux (how quickly the spectrum changes), and spectral roll off.

Mid-level Features (Stanzas/Musical Phrases) can be generated by aggregating the low-level features over a longer time window. This might involve calculating the mean, standard deviation, and range of MFCCs, pitch, and loudness over a musical phrase.

High-level Features (Full Track/Song) can be extracted for the entire track, and the feature vector could be a summary of all the mid-level features. High-level, semantic features like a genre classification vector or an emotion vector (e.g., “upbeat” or “sad”) may also be used. The final feature vector for the whole song may be a concatenation of these multi-level features, creating a rich representation of the audio's structure and content.

Video hierarchies can be based on time, events, or semantic content (e.g., full video, scene, shot, frame). A similar hierarchical extraction process may be used. Visual features may be extracted using computer vision techniques like Histogram of Oriented Gradients (HOG) to describe shapes and objects, or Local Binary Patterns (LBP) for texture analysis. Color Histograms can be used to quantify the distribution of colors in a frame. Motion vectors or optical flow may be used to describe the movement between frames.

Mid-level Features (Scenes) can be an aggregation of the low-level features from all its constituent frames. For example, an average color histogram for a scene, or an average motion intensity to distinguish between a fast-paced action scene and a static dialogue scene may be determined. An object presence vector that indicates which objects or people are present throughout the scene can be used.

High-level Features (Full Video) can include the final vector for the entire video combining all the scene-level feature vectors. This can be performed by averaging them or by using a sequence model (like a recurrent neural network) to capture the temporal progression of scenes. Additionally, a vector from a video transcript analysis (e.g., a topic modeling vector) can be incorporated to add a semantic layer. The final vector can be a summary of the video's visual and semantic content across all levels.

For documents, a hierarchy is typically based on logical structure like chapters, sections, paragraphs, and sentences. Feature vector extraction often relies on natural language processing (NLP). Low-level Features (Words/Sentences) can include words that are represented by word embeddings like Word2Vec or GloVe, which map words to dense vectors based on their context. Sentences can be represented by averaging the word embeddings or using a model like a sentence-level encoder.

Mid-level Features (Paragraphs/Sections) can be represented by aggregating the feature vectors of their constituent sentences. This can be based on averaging the vectors or using more advanced techniques like hierarchical attention networks that weigh the importance of different sentences. A topic modeling vector for each section, indicating its key themes, may be generated.

High-level Features (Full Document) can include a final document vector as a combination of all the section-level vectors. This can be performed through a final aggregation step. To capture the full context, a document vector may also include named entity vectors (e.g., a vector representing all the people, places, and organizations mentioned in the document) and a sentiment vector to summarize the overall tone. The final feature vector for the document can be a rich, multi-dimensional representation of its content and structure.

A knowledge graph can be generated from hierarchies by representing the hierarchical structure as a network of interconnected nodes and edges. The hierarchy's elements become the nodes, and the relationships between them, which are explicit in the hierarchical structure, are defined as edges. This process transforms a tree-like organization into a graph-based structure that is more flexible and can be queried in more complex ways. The knowledge graph can include a triple or (subject, predicate, object) relationship. This is a unit of information storage. Each item in the hierarchy becomes an entity or a node in the graph. For a document, this could be the full document, a chapter, a section, or even a specific paragraph. For a video, it could be the video itself, a scene, a shot, or an object within a frame. The hierarchical relationships become the edges or predicates that connect the nodes. The most common relationship is a parent-child or is-a-part-of relationship. For example, a chapter is is-a-part-of a book, and a scene is is-a-part-of a video. More specific relationships may be defined based on the content, such as a scene contains a character or a paragraph discusses a specific topic.

In order to generate the knowledge graph from the hierarchical structure, a top-down approach may be adopted. The top-level item (e.g., the full document, video, or audio file) may be the root node. Each subsequent sub-item (e. g., chapter, scene, etc.) may be a child node. For every parent-child pair in the hierarchy, a corresponding edge in the knowledge graph may be created. The direction of the edge typically flows from the parent to the child, representing the hierarchical flow. For example, Full-Video, HAS-SCENE, Scene-1, Scene-1, HAS-SHOT, Shot-A, and Shot-A, CONTAINS, Red-Car.

Properties or attributes may be added to the nodes and edges to enrich the graph. These properties can be the features extracted during the hierarchy generation process. Node Properties can include, for example, a scene node that might have properties for its timestamp, average-light-intensity, and dominant-color. A paragraph node might have properties for its word-count and sentiment. An edge from a scene to a shot may have a property indicating the duration of the shot.

The real power of a knowledge graph emerges when hierarchies from different media types may be inter-connected. For example, if a document and a video are both about a specific product, a new entity for that product may be created. The relevant sections of the document and video may be linked to that new product entity. This creates a multi-modal knowledge graph, enabling query processing across different media types. The knowledge graph can be used to answer complex queries that go beyond simple retrieval, such as “Find all videos and documents that mention the Red-Car in a low-light scene with a negative sentiment.”

Generally speaking, existing LLMs may be provided with a portion of media content (e.g., in portable document format (PDF), Motion Picture Experts Group-4 format (MP4), Tagged Image File Format (TIFF), and so forth) and a user may query the LLM for a response. However, another user querying the same media content would need to separately upload the media content in order for the LLM to process it. This is evidently inefficient and uses computational resources that are valuable. Also, for example, the LLM would provide a response based on the uploaded media content and remain oblivious to similar attributes, and/or information in related media. Indeed, when a user uploads a first piece of media content to the LLM, the first piece of media content is retained in a temporary buffer unique to the user. The first piece of media content is not available to other users, and when the first user uploads a second piece of media content or initiates another chat session, the first piece of media content may no longer be available, and the user may need to re-upload it. Also, for example, data associated with a prior chat session related to the first piece of media content may be lost as well.

Also, for example, as noted above, when a second user wishes to interact with the first piece of media content, the second user would likely upload it separately, and a separate temporary buffer would be created for the second user. The LLM is likely to summarize, analyze, and respond to user queries in different ways, providing inconsistent responses to the same queries. In some aspects, such inconsistent responses may be minimized using prompt engineering that can predetermine a set of ranked prompts that may cause the LLM to provide similar responses. However, such an approach is feasible when the temporary buffer is shared between users.

Such problems get scaled up in an enterprise setting due to the substantial number of media items, and the large number of users querying the same or similar media items. The costs associated with such challenges can scale up quickly. Accordingly, it is desirable to have a corpus of media content 702 where enterprise data is stored, and multiple users may access and interact with the documents.

An LLM may be provided with a knowledge graph, or a portion thereof, and instructed to use data only from such a knowledge graph to provide responses to user queries.

In some embodiments, the extracted entities and characteristics of the media can be transformed into a hierarchical structure, which help generate the knowledge graph 702. For example, the hierarchical structure may be organized based on one or more characteristics of the media content.

As described herein, the knowledge graph may comprise of nodes and edges, wherein the nodes represent entities and portions of media content, and an edge between two nodes is indicative of a relationship between respective entities and portions of media content associated with the two nodes. In some embodiments, a knowledge graph may include multiple forms of media. In another example, a first knowledge graph may be associated with one type of media content, and a second knowledge graph may be associated with a second type of media content. In some embodiments, a first node may be a component of a first knowledge graph and may be connected by an edge to a second node, which is in a second knowledge graph.

In some embodiments, the entities and media characteristics are extracted 704 through a named entity recognition (NER) system, which may receive input from the corpus of media content 702 and identify entities and relationships to generate a knowledge graph 706. In some embodiments, the enterprise may already have a customized topology. For example, customers may have a particular product, and a normal dictionary may not include terms associated with the product, and/or may have a different meaning than what is intended in the documents. For example, the term “civic” in HONDA CIVIC® has a particular meaning (e.g., a model of a car) that is different from the ordinary meaning of the term “civic” as used in English. Generally, the named entity recognition (NER) system may not be familiar with such contextual use of terms that are not well-known. For example, although the named entity recognition (NER) system is likely to recognize HONDA CIVIC® as a model of a car, it is less likely to recognize less commonly known terms, internal organizational product references, internal project names, and so forth. Accordingly, named entity recognition (NER) system may receive input from customized topology to generate a contextually aware knowledge graph 706. Also, for example, the knowledge graph 706 may incorporate the hierarchical structure that is determined based on media characteristics.

In some embodiments, from the knowledge graph, a plurality of identifiers 708 may be generated. In some embodiments, nodes in the knowledge graph may be associated with a given identifier of the plurality of identifiers. In some embodiments, a plurality of feature vectors 710 may be generated based on the hierarchical structure of the media content, wherein a given feature vector of the plurality of feature vectors is associated with a given one or more identifiers. Also, for example, the feature vectors may be embedded in an embedding space where the distance between two feature vectors may correspond to a weight of a link between entities in the knowledge graph 706. For example, two entities that are strongly linked in the knowledge graph 706 may be embedded closer together, and two entities that are weakly linked in the knowledge graph 706 may be embedded further apart. In some embodiments, the feature vectors may be calculated in the same way, regardless of the type of node the identifier it is associated with represents. In some embodiments, nodes representing different characteristics may have different types of feature vectors. In some embodiments, one feature vector may be associated with one or more identifiers, and therefore with one or more nodes.

In some embodiments, a user 712 may interact with a chat interface 714. In some embodiments, the chat interface may be configured for multimodal interaction. Multimodal interaction may include receiving audio input from a user and responding with audio output. In some embodiments, the chat interface may be configured to receive natural language input and configured to provide natural language output. In some embodiments, the chat interface may be configured to receive haptic input, or image input. In some embodiments, the chat interface may be configured for multilingual interaction. In some embodiments, the chat interface may be configured to receive input in multiple languages, and to provide output in multiple languages. In some embodiments, the chat interface may be configured to translate output into a different language than the original.

In some embodiments, the chat interface may receive a user query 716, which may then be provided to the embedding model 718. The embedding model may extract a query embedding 720. Query embedding 720 may be indicative of an intent of the user query. In some embodiments, the user query may request an answer to a specific question. In some embodiments, the user query may request a summary of a specific piece of media content. In some embodiments, the query embedding may be in the form of a vector. The query embedding may be compared to the plurality of feature vectors 722. In some embodiments, more than one similar feature vector may be identified. The identified similar feature vectors may then be used to identify regions on the knowledge graph that are to be traversed in selecting one or more relevant subgraphs.

Integrating a knowledge graph (KG) into the generative AI model for query-answering is a powerful technique, often referred to as Retrieval-Augmented Generation (RAG). This approach overcomes key limitations of LLMs, such as the tendency to “hallucinate” (generate factually incorrect information) and their inability to access real-time or domain-specific knowledge. A technical challenge involves transforming the structured, interconnected data of a knowledge graph into a format an LLM can understand and use and then instructing the LLM to use only this data for its response.

The first step is to intelligently query the knowledge graph to retrieve relevant information based on the user's input. This may not be a simple vector search. As described herein, the user's natural language query may be first translated into a structured query language for the knowledge graph, such as SPARQL Protocol and RDF Query Language (SPARQL) (for Resource Description Framework (RDF) graphs) or Cypher (for Neo4j graph databases). The LLM itself can be used as a “translator” for this step. For example, a prompt can be crafted to instruct the LLM to convert a user query into a SPARQL query. One advantage of using a knowledge graph is the ability to perform multi-hop reasoning. This means the system can follow multiple relationships (hops) to find an answer that is not directly connected to the initial query entity. For instance, to answer “What is the dominant color of the car shown in the video scene that discusses the company's Q3 financials?”, the system would have to find the document/video clip about “Q3 financials,” identify the related video scene (first hop), find the entities (e.g., “car”) within that scene (second hop), and retrieve the “dominant-color” property of the car entity (third hop).

Instead of passing the entire knowledge graph to the LLM (which may be unfeasible due to the LLM's context window size), the system may retrieve one or more small, relevant subgraphs. These relevant subgraphs contain the entities and relationships necessary to answer the user's query and serves as the “source of truth.”

The knowledge graph may include entity weights associated with entities. The entity weight for a particular entity may indicate the entity's relevance in the text, with higher weights indicating stronger relationships. This helps highlight which entities are highly significant to understanding the context within the document. For example, a general noun may be detected in the media content and may not be identified as an entity. Accordingly, the general noun may be persisted in the knowledge graph 706 as a general noun and may be associated with a weight of “0.” In some embodiments, the entity weight may be based on an entity frequency in the media content indicating how often the entity appears in the specific section of the media content. In another example, the entity weight may be determined based on an entity frequency across the entire piece of media represented in the knowledge graph. In another example, entity weights associated with entities a user has identified previously as important may be higher than entities the user has not identified as important. One or more of the above may be combined to obtain the entity weight. By comparing such factors, a determination may be made as to how much an entity stands out in a particular segment of media content. Additionally, logarithms may be used to compress a scale of such comparisons, ensuring that very high or very low frequencies do not dominate weight determinations. A logarithmic adjustment can ensure a more balanced evaluation of entity importance.

Utilizing the entity weights, a graph traversal algorithm can be one approach to determine a relevant subgraph. In some embodiments, the graph traversal algorithm begins at an initial node identified by comparing the query embedding with a plurality of feature vectors. The edges connecting the initial node to additional nodes are then traversed until a next node is reached with an entity weight over an entity threshold, and nodes with entity weights that do not meet the entity threshold are not traversed. The entity threshold may depend on several factors, including, for example, a type of query, an intent of the query, a location of the entity within the knowledge graph 706, a type of user entering the query (e.g., some users may have different access permissions within the knowledge graph) and so forth. In some embodiments, different portions of the knowledge graph may be associated with different entity thresholds.

At least one relevant subgraph 726 may be extracted from the knowledge graph, based on the traversal. In some embodiments, a first relevant subgraph may be extracted from the knowledge graph based on a first identifier in a similar feature vector, and a second relevant subgraph may be extracted from the knowledge graph based on a second identifier in the similar feature vector. In some embodiments, a first relevant subgraph may be extracted from the knowledge graph based on a first identifier in a first similar feature vector, and a second relevant subgraph may be extracted from the knowledge graph based on a second identifier in a second similar feature vector. Multiple subgraphs may be provided to give the LLM more information, improving the corpus of information that the LLM has access to. The at least one relevant subgraph may include the nodes identified by the identifier and include context necessary to generate the user response.

Context may comprise nodes connected to the identified node, to a certain degree. In some embodiments, context comprises nodes with a similar topic or relevant information, which are connected to the identified node. In some embodiments, relevancy may be determined by a graph traversal algorithm, wherein edges are traversed until the next node is reached with an entity weight over an entity threshold, and nodes with entity weights that do not meet the entity threshold are not traversed. In some embodiments, the entity weights of entities a user has identified previously as important may be higher than entities the user has not identified as important.

In some embodiments, once the relevant subgraph is retrieved, it may be formatted for the LLM. LLMs are trained on unstructured text, so the structured graph data may be “linearized.” For example, textual serialization may be performed. This involve converting the subgraph into a plain text format. This can be done in several ways, such as by listing out the (subject, predicate, object) triples. For example: (Full-Video, HAS-SCENE, Scene-1), (Scene-1, CONTAINS, Red-Car), (Red-Car, HAS-COLOR, Red). The triples may be converted into human-readable natural language sentences to make them more digestible for the LLM. For example, “The Full-Video has a scene called Scene-1. Scene-1 contains a Red-Car. The Red-Car has the color red.” The subgraph may be formatted as a structured text document using JSON or Markdown. This provides clear formatting and can help the LLM better parse the information.

The extracted at least one relevant subgraph 726 and the user query embedding 720 may then be provided to LLM 728. LLM 728 may also be given instructions to generate a response 730 based on the extracted at least one relevant subgraph 726 and the user query embedding 720. The response generated by LLM 728 may be provided to the user 712 through the chat interface 714.

For example, a prompt may be engineered to ensure the LLM uses only the provided data. A system prompt defines the LLM's role and constraints. It can contain explicit instructions like “You are a factual assistant. Your sole purpose is to answer user queries using only the information provided in the context below. Do not use any external knowledge. If the answer cannot be found in the provided data, state that you do not have enough information.” The linearized subgraph data may be inserted here. This acts as the LLM's “knowledge base” for this specific interaction. The context can be prepended with a clear label, such as “Source Data:” or “Knowledge Graph Content:”. The user query as input by the user may be placed at the end of the prompt. By combining a strong system prompt with a curated, relevant subgraph, the LLM is “grounded” in factual data. This architecture minimizes the risk of hallucinations and provides verifiable, auditable responses. The user knows the answer comes from a specific source, which can be traced back to the original knowledge graph and media hierarchies.

The knowledge graph 706 for a given media content may be very large. Accordingly, providing the entire knowledge graph to LLM 728 would likely result in unnecessary use of computational resources. Additionally, for example, providing the entire knowledge graph to the LLM 728 may cause LLM 728 to take longer to process the information and generate a response. Given the volume of information and the likely volume of simultaneous queries to be received from different users, providing the entire knowledge graph 706 to the LLM 728 is not practical. For example, with several media content items having overlapping information, LLM 728 is likely to generalize from the information in different overlapping entities to generate a response that is unlikely to be accurate and may also not be relevant to the query. Accordingly, the identifying of the relevant subgraph 726 that includes information from the media content that is pertinent to responding to the user query is a significant technical improvement that solves these technical challenges. Such an approach allows for considerable savings in terms of computational resources (processor time, memory, data traffic, tokens, etc.), decreases response time, and increases accuracy and relevance of the response to the query.

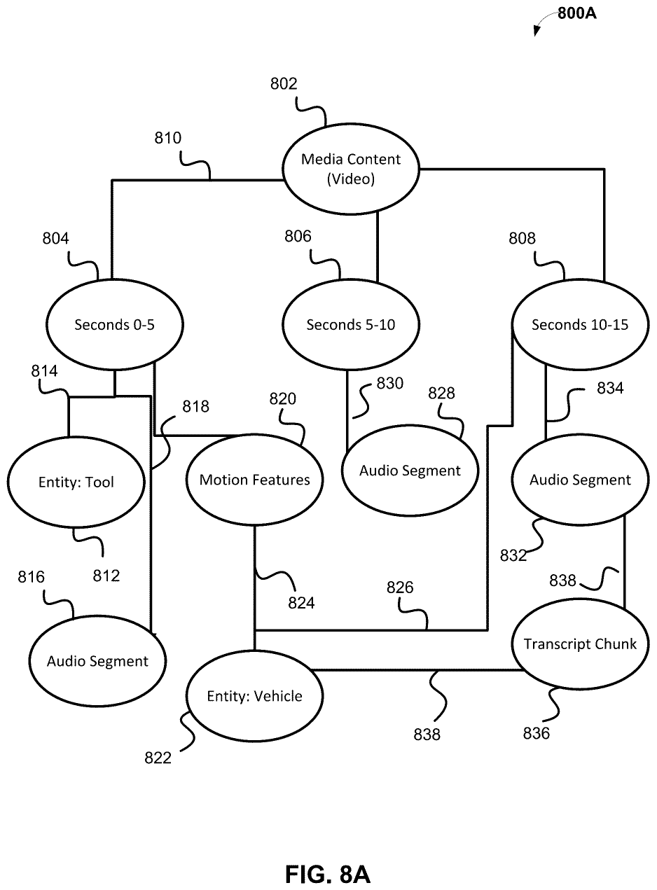

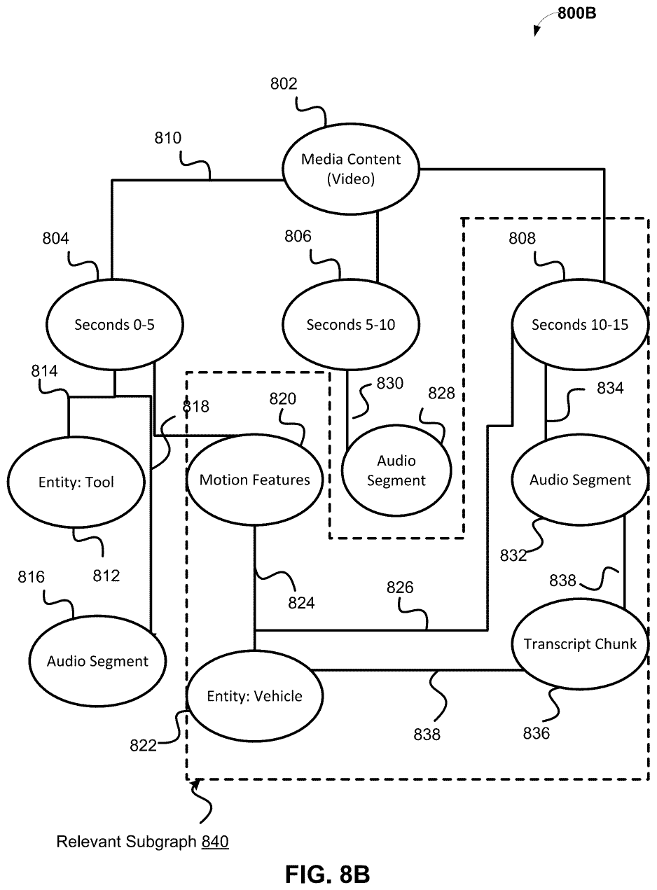

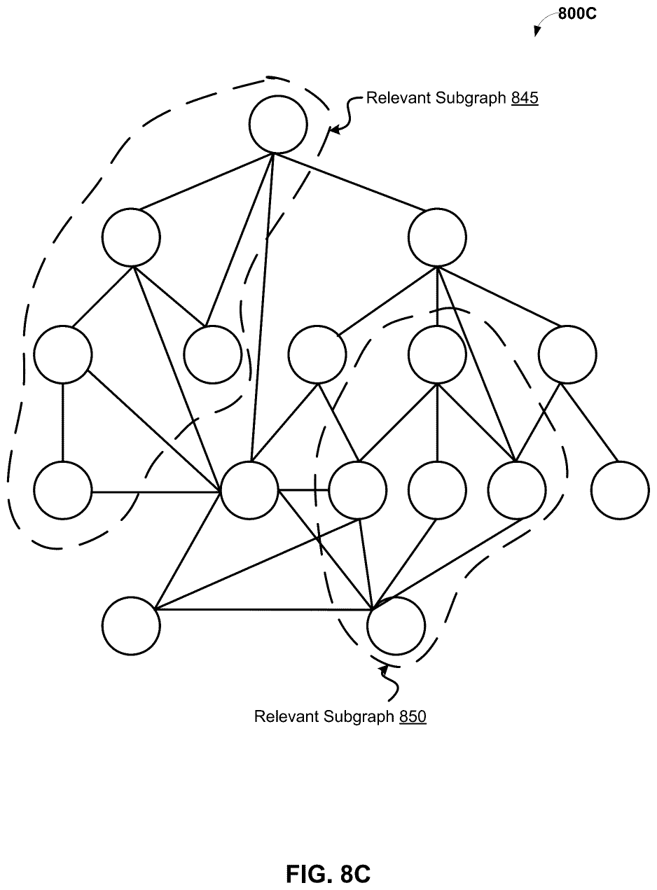

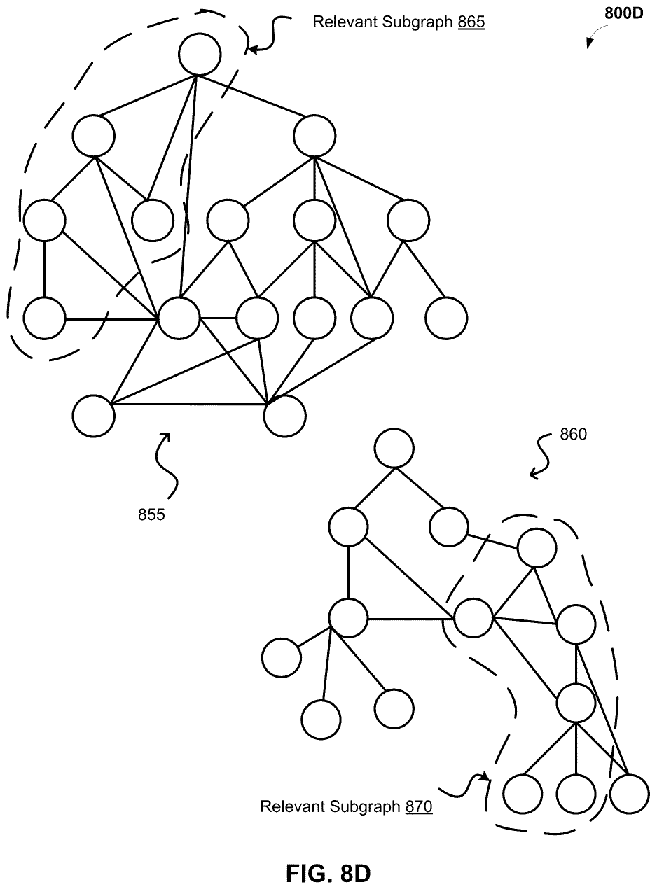

FIG. 8A illustrates an example view 800A of the knowledge graph realized as a line graph, in accordance with example embodiments. In some embodiments, the header 802 represents media content, in this case a video. In some embodiments, a video may be separated into portions of time by timestamps 804, 806, and 808, which each comprises a node associated with that portion of video. For example, a timestamp node may be connected to the header 802 by an edge 810. The edge 810 may indicate a relationship between the header 802 and the portion of media content identified by the timestamp node 804. In some embodiments, entities and other characteristics of the media are also connected to the timestamp nodes, if they are related in content. For example, the entity “tool” 812, corresponds to timestamp node 804 of the video. In some embodiments, the two nodes are connected by an edge 814, which indicates that “tool” likely occurs in or is related to “Seconds 0-5” of the video. In some embodiments, the video may also be divided up into chunks of audio, separately from video. For example, audio segment 816 is a node representing the chunk of audio occurring in “Seconds 0-5” of the video. Audio segment 816 is connected to timestamp node 804 by edge 818. In some embodiments, the motion features occurring in “Seconds 0-5” of the video are also represented as a node 820. The motion features node 820 may also be connected to an entity “Vehicle” 822 by an edge 824. In some embodiments, “Vehicle” 822 may also be connected by edge 826 to timestamp node 808. This implies that “Vehicle” 822 is present in the video segment 804, “Seconds 0-5” as well as video segment 808, “Seconds 10-15”. In some embodiments, timestamp node 806 is connected to audio segment 828 by edge 830. Nodes may have many connections, as entities and segments of information may be present in multiple portions of video. Timestamp node 808 is connected to audio segment 832 through edge 834. In some embodiments, transcript chunk 836 may represent a portion of the transcript of the audio segment 832 of the video 802. Transcript chunk 836 is connected to the audio segment 832 through an edge 838, which indicates that their content is related. In some embodiments, transcript chunk 836 may contain a reference to entity “Vehicle” 822, hence the two are connected by edge 838.

FIG. 8B illustrates an example view 800B of the knowledge graph realized as a line graph, visualized with an extracted relevant subgraph highlighted, in accordance with example embodiments. In some embodiments, relevant subgraph 840 indicates an example of nodes that have been selected to extract as a relevant subgraph. For example, in a video detailing the specifications of a car, a user may want to know the video publisher's opinion on mileage of the car. In some embodiments, a query embedding representing the intent of the user's query may be created. In some embodiments, the query embedding will then be compared with the plurality of feature vectors, which correspond to one or more identifiers, which correspond to nodes on the knowledge graph 800. In some embodiments, transcript chunk node 836 may offer the video publisher's opinion on the mileage of the car. Therefore, a feature vector representing transcript node 836 may have the shortest distance in the embedding space from the user query embedding. Therefore, transcript chunk node 836 can be explored using the graph traversal algorithm. In some embodiments, edges between nodes may represent related content. In some embodiments, relevant entities to the user query may include the vehicle 822, as well as potentially the motion features 820 of the car. In some embodiments, audio segment 832 and transcript chunk 836 may also include terms or tone that are relevant to the query. In some embodiments, the entity scores of these nodes may therefore pass the entity threshold, and through the graph traversal algorithm may be selected for the relevant subgraph.

In some embodiments, a size and/or shape of the extracted relevant subgraph may vary. For example, the entity threshold of the graph traversal algorithm may be set very low, which may result in a much larger extracted relevant subgraph, which includes nodes with potentially less significant relationships. In some embodiments, a larger extracted relevant subgraph may include more context for an LLM to use. However, a larger extracted relevant subgraph may require more computational power to parse and may include nodes that are less relevant to the user query. In some embodiments, the entity threshold of the graph traversal algorithm may be set high, which may result in a smaller extracted relevant subgraph, which includes nodes that are very strongly related to the query embedding. In some embodiments, a smaller extracted relevant subgraph may require fewer computational resources to parse and may be less likely to include unrelated nodes. However, a smaller extracted relevant subgraph may include less context for the LLM to use when generating a response.

FIG. 8C illustrates an example view 800C of a knowledge graph realized as a line graph, visualized with two extracted relevant subgraphs highlighted, in accordance with example embodiments. In some embodiments, multiple relevant subgraphs 845 and 850 may be extracted from a single knowledge graph. For example, when an embedding model is processing a user query, there may be one or more intents associated with a single user query. For example, a user query may include multiple questions. In some embodiments, an embedding model may produce one or more query embeddings. In some embodiments, those one or more query embeddings may be compared to the plurality of feature vectors representing a knowledge graph, and one or more similar feature vectors may be selected. In some embodiments, a graph traversal algorithm may be used to extract two or more relevant subgraphs. The number of potentially extracted relevant subgraphs is not limited to the examples described herein. In an additional example, a single query embedding may require context that is present in multiple separate nodes on the knowledge graph, and one or more similar feature vectors may be extracted. In some embodiments, based on the one or more similar feature vectors, a graph traversal algorithm may be used to extract one or more relevant subgraphs.

FIG. 8D illustrates an example view 800D of two knowledge graphs realized as line graphs, visualized with two extracted relevant subgraphs highlighted, in accordance with example embodiments. In some embodiments, a corpus of media items may include a variety of media formats and characteristics. In some embodiments, one hierarchical structure may organize the entire corpus of media content and characteristics. In additional examples, the different media items may be organized into multiple separate hierarchical structures resulting in multiple, potentially interconnected, knowledge graphs. For illustrative purposes, a first knowledge graph 855 is represented as a line graph, and a second knowledge graph 860 is represented as a line graph. In some embodiments, depending on the intent of the query embedding, feature vectors may be identified from the comparison of the query embedding and the plurality of feature vectors that are located in two separate knowledge trees. In some embodiments, using a graph traversal algorithm, those identified feature vectors may then be used to identify a first extracted relevant subgraph 865, and a second extracted relevant subgraph 870. In some embodiments, the graph traversal algorithm used to determine first extracted relevant subgraph 865 may be a separate graph traversal algorithm than the graph traversal algorithm used to determine second extracted relevant subgraph 870. In some embodiments, the hierarchical structure that organizes first knowledge graph 855 may be a different hierarchical structure than the hierarchical structure that organizes second knowledge graph 860.

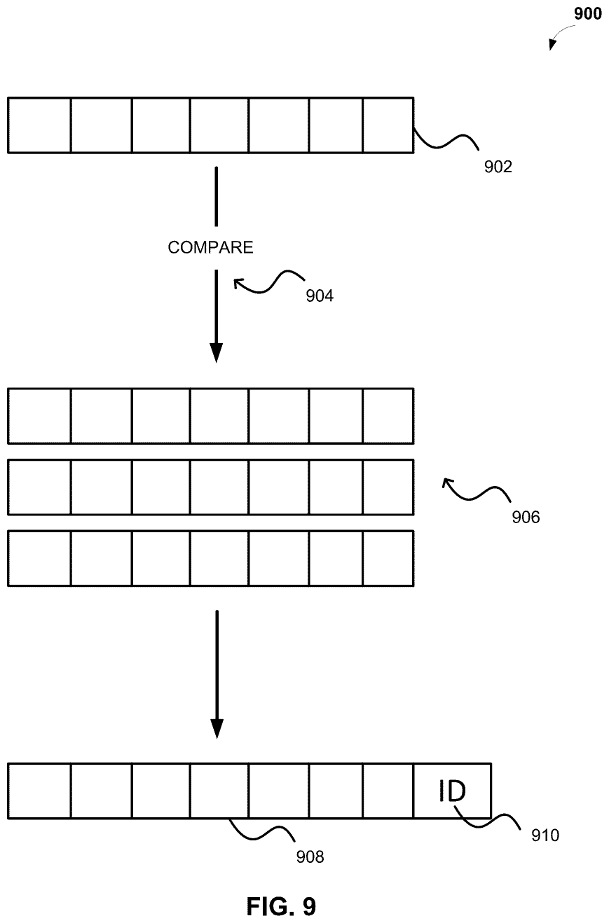

FIG. 9 illustrates an example view 900 of a query embedding and a plurality of feature vector embeddings realized as arrays, in accordance with example embodiments. In some embodiments, query embedding 902 may be represented as a generic array. However, query embedding 902 may also take the form of a vector, a matrix, and so forth. In some embodiments, query embedding 902 may be compared through a comparison process 904 to a plurality of feature vectors 906. Comparison process 904 may comprise a similarity metric, a distance metric, and other methods for determining similarity. In some embodiments, from this comparison process 904, at least one feature vector 908 is identified as similar to the query embedding 902. In some embodiments, this at least one similar feature vector 908 is associated with an identifier 910, represented in FIG. 9 as a generic “ID”. In some embodiments, identifier 910 associates the at least one similar feature vector 908 to a node in a knowledge graph.

In some embodiments, identifier 910 may comprise a reference to a specific identified node. In some embodiments, identifier 910 may comprise a specific keyword, and may be associated with one or more nodes. In some embodiments, identifier 910 may be associated with a specific location within the embedding space. In some embodiments, one or more nodes may be associated with the specific location within the embedding space that the identifier 910 is associated with.

### Example Data Network

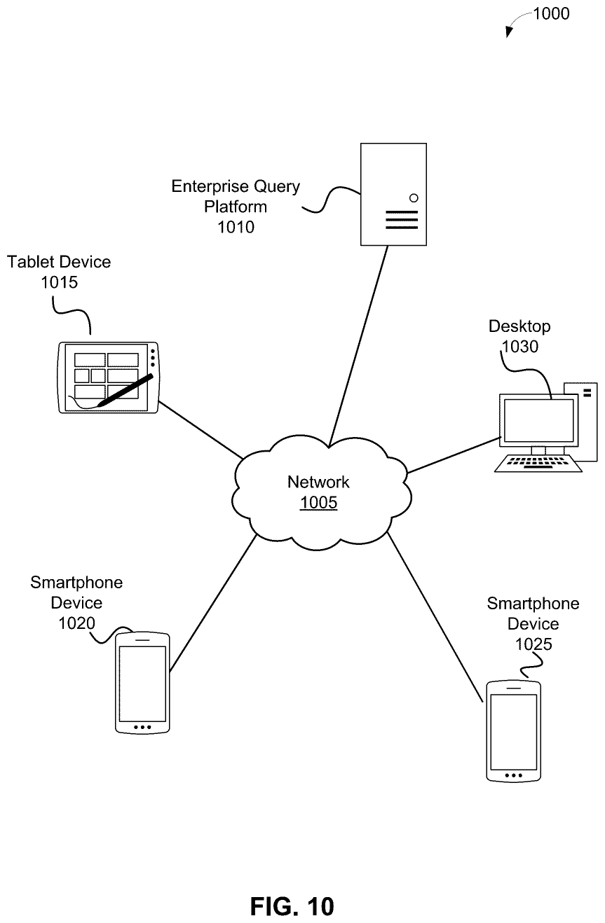

FIG. 10 depicts a distributed computing environment 1000, in accordance with example embodiments. Distributed computing environment 1000 includes an enterprise query platform 1010 (e.g., a server device, a distributed system, a hybrid cloud, a cloud server, and so forth) that is configured to communicate, via network 1005, with one or more computing devices, including, but not limited to, mobile devices such as a tablet device 1015, a smartphone device 1020, another smartphone device 1025 equipped with a computing device, and a desktop. Network 1005 may correspond to a local area network (LAN), a wide area network (WAN), a wireless local-area network (WLAN), a wireless wide area network (WWAN), an intranet, a public Internet, or any other type of network configured to provide a communications path between networked computing devices. Network 1005 may also correspond to a combination of one or more networks.

It may be noted that these devices shown are for illustrative purposes only. Generally speaking, media content sharing platform 1010 may be communicatively linked to a computing device over network 1005. In fact, it may be linked to multiple computing devices (e.g., millions) in distributed computing environment 1000. In addition to the computing devices illustrated in FIG. 10, other devices such as mobile computing devices, wearable devices, head-mountable devices (HMD), augmented reality (AR) devices, virtual reality (VR) devices, aircrafts, boats, drones, and so on are possible. The devices may be directly connected to network 1005 or may be indirectly connected to network 1005 via another device that is directly connected.

Enterprise query platform 1010 may be configured to perform one or more functions that enable users to interact with a corpus of documents (e.g., enterprise documents, social media posts, etc.).

Generally, the enterprise query platform 1010 described herein may be available as a platform, as an application programming interface (API), an application-specific integrated circuit (ASIC), as a service (e.g., Software as a Service (Saas), Machine Learning as a Service (MLaaS), Analytics as a Service (AnaaS), Platform as a Service (PaaS), Knowledge as a Service (KaaS), and so forth.

### Example Computing Device

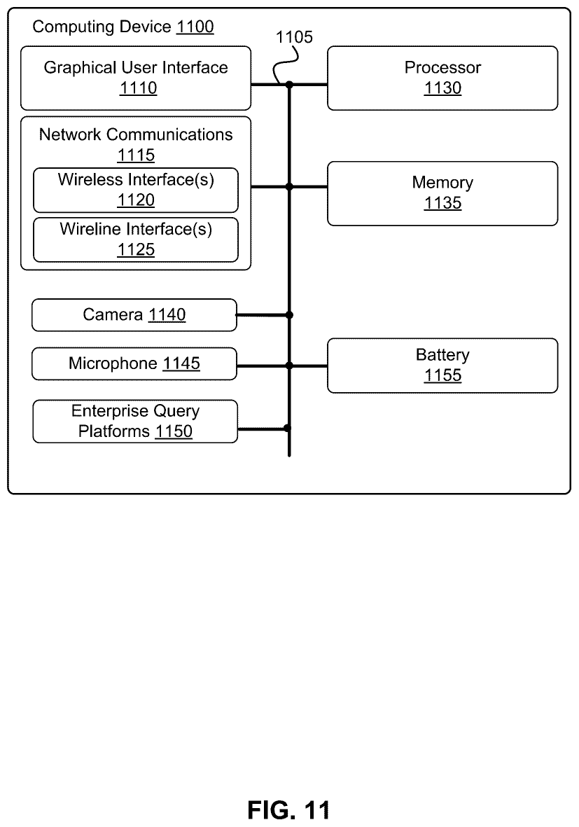

FIG. 11 is a block diagram of an example computing device 1100, in accordance with example embodiments. In particular, computing device 1100 shown in FIG. 11 can be configured to perform at least one function of and/or related to user interactions with media content by optimizing a retrieval of factual content for a generative artificial intelligence (AI) model, and/or method 1200.

Computing device 1100 may include modules to provide various functionalities, such as for example, a graphical user interface 1110, network communications 1115, a processor 1130, memory 1135, a camera 1140, a microphone 1145, and battery 1155, all of which may be linked together via a system bus, or other connection mechanism 1105.

Graphical user interface 1110 can be configured to send data to and/or receive data from external user input/output devices such as such as a touch screen, a computer mouse, a keyboard, a microphone, external monitors, and the like. Graphical user interface 1110 can also be configured to generate audio and/or video outputs.

Network communications 1115 can be configured to provide one or more wireless interface(s) 1120 and/or one or more wireline interface(s) 1125 that can be configured to communicate via a network (e.g., network 705 of FIG. 7). Wireless interface(s) 1120 can include wireless transmitters, receivers, and/or transceivers (e.g., for Bluetooth, Wi-Fi, near-field communications, etc.). Wireline interface(s) 1125 can include wireline transmitters, receivers, and/or transceivers (e.g., Ethernet transceiver).

In some examples, network communications 1115 can be configured to provide reliable, secure, and/or authenticated communications. For example, network communications 1115 can be configured to provide encrypted data. The type of encryption may depend on a type of network interface, capabilities of a network itself, a type of data to be transmitted, and so forth.

Processor 1130 can include a general-purpose processor, and/or special purpose processors (e.g., digital signal processors, graphics processing units (GPUs), media processing processors, image processing processors, text processing processors, speech processing processors, etc.). Processor 1130 can be configured to execute computer-readable instructions that are contained in memory 1135 and/or other instructions as described herein.

Memory 1135 can include one or more non-transitory computer-readable storage media that can be read and/or accessed by processor 1130. The one or more computer-readable storage media can include volatile and/or non-volatile storage components. In some examples, memory 1135 can be implemented using a single physical device, while in other examples, memory 1135 can be implemented using multiple physical devices.

Memory 1135 can include computer-readable instructions that, when executed by processor 1130, enable computing device 1100 to provide for some or all of the functionality of the computing devices and/or enterprise query platforms described herein. The functions include receiving, by a chat interface of a computing device, a user query. The functions also include determining a query embedding for the user query, wherein the query embedding is indicative of an intent of the user query. The functions further include receiving a plurality of feature vectors from a hierarchical structure of the media content, wherein the hierarchical structure is based on a characteristic of the media content, and wherein a given feature vector of the plurality of feature vectors is associated with a portion of the media content. The functions further include comparing the query embedding with the plurality of feature vectors. The functions also include identifying, based on the comparing, one or more feature vectors that are similar to the query embedding, wherein the given feature vector is associated with an identifier that identifies a node in a knowledge graph, the knowledge graph comprising nodes and edges, wherein nodes represent entities and portions of media content, and an edge between two nodes is indicative of a relationship between respective entities and portions of media content associated with the two nodes. The functions further include traversing one or more edges of the knowledge graph, wherein the traversing is based on nodes corresponding to identifiers associated with the identified one or more feature vectors. The functions further include extracting, based on the traversing, at least one relevant subgraph of the knowledge graph wherein the at least one relevant subgraph comprises content relevant to the user query. The functions also include providing the user query and the extracted at least one relevant subgraph to the generative AI model, with instructions to generate a response based on the extracted at least one relevant subgraph. The functions further include receiving a response from the generative AI model, and providing, by the chat interface and in response to the user query, the response from the generative AI model.

In some examples, computing device 1100 can include camera 1140. Camera 1140 can include still and/or video cameras.

In some examples, computing device 1100 can include microphone 1145. Microphone 1145 can be configured to capture audio inputs (e.g., speech, music, and so forth).

In some examples, computing device 1100 can include enterprise query platforms 1150. Enterprise query platforms 1150 may be configured to enable user interactions with media content by optimizing a retrieval of factual content for a generative artificial intelligence (AI) model as described herein.

Battery 1155 is configured to provide electrical power to computing device 1100. Each battery can, when electrically coupled to the computing device 1100, function as a source of stored electrical power for computing device 1100. Battery 1155 may be one or more of portable, removable, rechargeable, etc. The term battery is generally used herein to denote a power supply (wired or otherwise).

### Example Methods of Operation

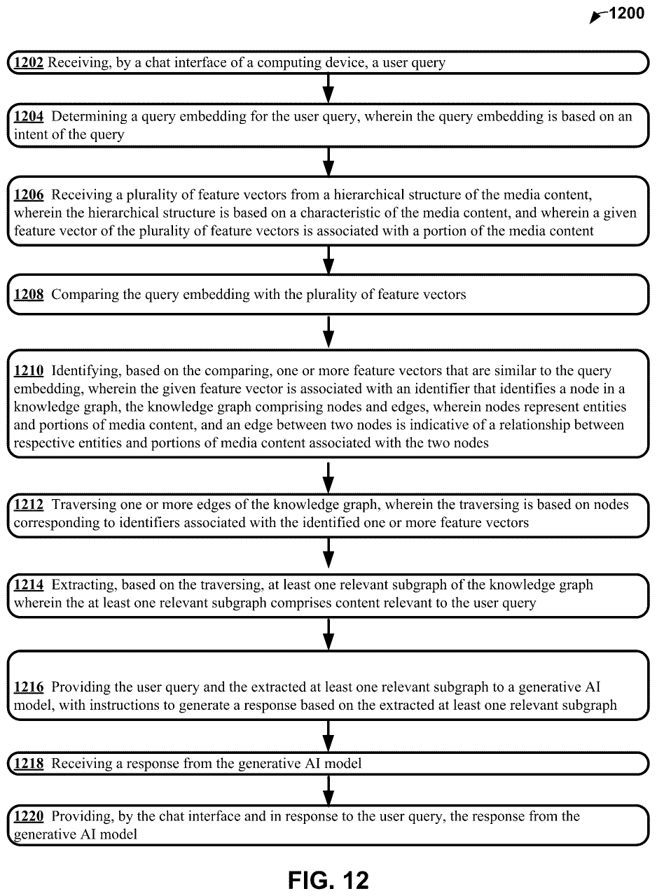

FIG. 12 is a flowchart of a method 1200 for user interactions with media content by optimizing a retrieval of factual content for a generative artificial intelligence (AI) model, in accordance with example embodiments. The method 1200 can begin at block 1202, where the method 1200 involves receiving, by a chat interface of a computing device, a user query.

At block 1204, the method 1200 includes determining a query embedding for the user query, wherein the query embedding is indicative of an intent of the user query.

At block 1206, the method 1200 includes receiving a plurality of feature vectors from a hierarchical structure of the media content, wherein the hierarchical structure is based on a characteristic of the media content, and wherein a given feature vector of the plurality of feature vectors is associated with a portion of the media content.

At block 1208, the method 1200 includes comparing the query embedding with the plurality of feature vectors.

At block 1210, the method 1200 includes identifying, based on the comparing, one or more feature vectors that are similar to the query embedding, wherein the given feature vector is associated with an identifier that identifies a node in a knowledge graph, the knowledge graph comprising nodes and edges, wherein nodes represent entities and portions of media content, and an edge between two nodes is indicative of a relationship between respective entities and portions of media content associated with the two nodes.

At block 1212, the method 1200 includes traversing one or more edges of the knowledge graph, wherein the traversing is based on nodes corresponding to identifiers associated with the identified one or more feature vectors.

At block 1214, the method 1200 includes extracting, based on the traversing, at least one relevant subgraph of the knowledge graph wherein the at least one relevant subgraph comprises content relevant to the user query.

At block 1216, the method 1200 includes providing the user query and the extracted at least one relevant subgraph to the generative AI model, with instructions to generate a response based on the extracted at least one relevant subgraph.

At block 1218, the method 1200 includes receiving a response from the generative AI model.

At block 1220, the method 1200 includes providing, by the chat interface and in response to the user query, the response from the generative AI model.

In some embodiments, the media content includes one or more of: (i) a video, (ii) an audio, and/or (iii) a document.

In some embodiments, the media content includes a video. The characteristic of the video include one or more of: (i) inter-frame motion features, (ii) a transcript of the video, (iii) a timestamp associated with a portion of the video, (iv) a frame of the video, (v) one or more audio segments, (vi) a light intensity level of the video, (vii) a color of the video, (viii) one or more entities appearing in the video, (ix) a texture of the video, and/or (vi) a musical content of the video.

In some embodiments, the media content includes an audio. The characteristic of the audio include one or more of: (i) one or more audio segments, (ii) a transcript of the audio, (iii) a timestamp associated with a portion of the audio, (iv) a musical content of the audio, (v) a tone of the audio, (vi) one or more entities appearing in the audio, and/or (vii) a pitch of the audio.

In some embodiments, the media content includes a document. The characteristic of the document include one or more of: (i) one or more pages of the document, (ii) one or more headings of the document, (iii) a section of the document, (iv) one or more entities appearing in the document, (v) a font of the document, and/or (vi) an image or diagram appearing in the document.

In some embodiments, the identifier may identify two or more nodes in the knowledge graph.

In some embodiments, a first node of the two or more nodes may be a component of a first knowledge graph, and wherein a second node of the two or more nodes may be a component of a second knowledge graph.

In some embodiments, the first knowledge graph includes a first hierarchical structure of nodes, and wherein the second knowledge graph includes a second hierarchical structure of nodes.

In some embodiments, the first knowledge graph may be associated with a first type of media content, and wherein the second knowledge graph may be associated with a second type of media content.

In some embodiments, traversing one or more edges of the knowledge graph involves traversing more than one knowledge graph, and wherein the extracting of the at least one relevant subgraph involves extracting a first relevant subgraph from the first knowledge graph and extracting a second relevant subgraph from the second knowledge graph.

In some embodiments, the extracting of the at least one relevant subgraph involves extracting more than one relevant subgraph from the knowledge graph.

In some embodiments, the at least one relevant subgraph includes a collection of nodes and edges associated with the node corresponding to the identifier, and wherein the at least one relevant subgraph provides a context for the response to the user query when provided to the generative AI model.

In some embodiments, the chat interface is configured for multimodal interaction.

In some embodiments, the chat interface is configured for multilingual interaction.

In some embodiments, the generative AI model is configured for multimodal interaction.

In some embodiments, the generative AI model is configured for multilingual interaction.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A computer implemented method for user interactions with media content by optimizing a retrieval of factual content for a generative artificial intelligence (AI) model, comprising:
receiving, by a chat interface of a computing device, a user query;
determining a query embedding for the user query, wherein the query embedding is indicative of an intent of the user query;
receiving a plurality of feature vectors from a hierarchical structure of the media content, wherein the hierarchical structure is based on a characteristic of the media content, and wherein a given feature vector of the plurality of feature vectors is associated with a portion of the media content;
comparing the query embedding with the plurality of feature vectors;
identifying, based on the comparing, one or more feature vectors that are similar to the query embedding, wherein the given feature vector is associated with an identifier that identifies a node in a knowledge graph, the knowledge graph comprising nodes and edges, wherein nodes represent entities and portions of media content, and an edge between two nodes is indicative of a relationship between respective entities and portions of media content associated with the two nodes;
traversing one or more edges of the knowledge graph, wherein the traversing is based on nodes corresponding to identifiers associated with the identified one or more feature vectors;
extracting, based on the traversing, at least one relevant subgraph of the knowledge graph wherein the at least one relevant subgraph comprises content relevant to the user query;
providing the user query and the extracted at least one relevant subgraph to the generative AI model, with instructions to generate a response based on the extracted at least one relevant subgraph;
receiving a response from the generative AI model; and
providing, by the chat interface and in response to the user query, the response from the generative AI model.

2. The computer implemented method of claim 1, wherein the media content comprises one or more of: (i) a video, (ii) an audio, and/or (iii) a document.

3. The computer implemented method of claim 1, wherein the media content comprises a video, and wherein the characteristic of the video comprises one or more of: (i) inter-frame motion features, (ii) a transcript of the video, (iii) a timestamp associated with a portion of the video, (iv) a frame of the video, (v) one or more audio segments, (vi) a light intensity level of the video, (vii) a color of the video, (viii) one or more entities appearing in the video, (ix) a texture of the video, and/or (vi) a musical content of the video.

4. The computer implemented method of claim 1, wherein the media content comprises an audio, and wherein the characteristic of the audio comprises one or more of: (i) one or more audio segments, (ii) a transcript of the audio, (iii) a timestamp associated with a portion of the audio, (iv) a musical content of the audio, (v) a tone of the audio, (vi) one or more entities appearing in the audio, and/or (vii) a pitch of the audio.

5. The computer implemented method of claim 1, wherein the media content comprises a document, and wherein the characteristic of the document comprises one or more of: (i) one or more pages of the document, (ii) one or more headings of the document, (iii) a section of the document, (iv) one or more entities appearing in the document, (v) a font of the document, and/or (vi) an image or diagram appearing in the document.

6. The computer implemented method of claim 1, wherein the identifier identifies two or more nodes in the knowledge graph.

7. The computer implemented method of claim 6, wherein a first node of the two or more nodes is a component of a first knowledge graph, and wherein a second node of the two or more nodes is a component of a second knowledge graph.

8. The computer implemented method of claim 7, wherein the first knowledge graph comprises a first hierarchical structure of nodes, and wherein the second knowledge graph comprises a second hierarchical structure of nodes.

9. The computer implemented method of claim 7, wherein the first knowledge graph is associated with a first type of media content, and wherein the second knowledge graph is associated with a second type of media content.

10. The computer implemented method of claim 7, wherein traversing one or more edges of the knowledge graph comprises traversing more than one knowledge graph, and wherein the extracting of the at least one relevant subgraph comprises extracting a first relevant subgraph from the first knowledge graph and extracting a second relevant subgraph from the second knowledge graph.

11. The computer implemented method of claim 1, wherein the extracting of the at least one relevant subgraph comprises extracting more than one relevant subgraph from the knowledge graph.

12. The computer implemented method of claim 1, wherein the at least one relevant subgraph comprises a collection of nodes and edges associated with the node corresponding to the identifier, and wherein the at least one relevant subgraph provides a context for the response to the user query when provided to the generative AI model.

13. The computer implemented method of claim 1, wherein the chat interface is configured for multimodal interaction.

14. The computer implemented method of claim 1, wherein the chat interface is configured for multilingual interaction.

15. The computer implemented method of claim 1, wherein the generative AI model is configured for multimodal interaction.

16. The computer implemented method of claim 1, wherein the generative AI model is configured for multilingual interaction.

17. A computing device for user interactions with media content by optimizing a retrieval of factual content for a generative artificial intelligence (AI) model, comprising:
a memory; and
one or more processors, configured to perform operations comprising:
receiving, by a chat interface of the computing device, a user query;
determining a query embedding for the user query, wherein the query embedding is indicative of an intent of the user query;
receiving a plurality of feature vectors from a hierarchical structure of the media content, wherein the hierarchical structure is based on a characteristic of the media content, and wherein a given feature vector of the plurality of feature vectors is associated with a portion of the media content;
comparing the query embedding with the plurality of feature vectors;
identifying, based on the comparing, one or more feature vectors that are similar to the query embedding, wherein the given feature vector is associated with an identifier that identifies a node in a knowledge graph, the knowledge graph comprising nodes and edges, wherein nodes represent entities and portions of media content, and an edge between two nodes is indicative of a relationship between respective entities and portions of media content associated with the two nodes;
traversing one or more edges of the knowledge graph, wherein the traversing is based on nodes corresponding to identifiers associated with the identified one or more feature vectors;
extracting, based on the traversing, at least one relevant subgraph of the knowledge graph wherein the at least one relevant subgraph comprises content relevant to the user query;
providing the user query and the extracted at least one relevant subgraph to the generative AI model, with instructions to generate a response based on the extracted at least one relevant subgraph;
receiving a response from the generative AI model; and
providing, by the chat interface and in response to the user query, the response from the generative AI model.

18. The computing device of claim 17, wherein the chat interface of the computing device is configured for multimodal interaction.

19. The computing device of claim 17, wherein the chat interface of the computing device is configured for multilingual interaction.

20. The computing device of claim 17, wherein the generative AI model is configured for multimodal interaction.

21. The computing device of claim 17, wherein the generative AI model is configured for multilingual interaction.

22. A non-transitory, computer readable medium for user interactions with media content by optimizing a retrieval of factual content for a generative artificial intelligence (AI) model, having stored thereon program instructions that, upon execution by one or more computer processors, cause the one or more processors to perform operations comprising:
receiving, by a chat interface of a computing device, a user query;
determining a query embedding for the user query, wherein the query embedding is indicative of an intent of the user query;
receiving a plurality of feature vectors from a hierarchical structure of the media content, wherein the hierarchical structure is based on a characteristic of the media content, and wherein a given feature vector of the plurality of feature vectors is associated with a portion of the media content;
comparing the query embedding with the plurality of feature vectors;
identifying, based on the comparing, one or more feature vectors that are similar to the query embedding, wherein the given feature vector is associated with an identifier that identifies a node in a knowledge graph, the knowledge graph comprising nodes and edges, wherein nodes represent entities and portions of media content, and an edge between two nodes is indicative of a relationship between respective entities and portions of media content associated with the two nodes;
traversing one or more edges of the knowledge graph, wherein the traversing is based on nodes corresponding to identifiers associated with the identified one or more feature vectors;
extracting, based on the traversing, at least one relevant subgraph of the knowledge graph wherein the at least one relevant subgraph comprises content relevant to the user query;
providing the user query and the extracted at least one relevant subgraph to the generative AI model, with instructions to generate a response based on the extracted at least one relevant subgraph;
receiving a response from the generative AI model; and
providing, by the chat interface and in response to the user query, the response from the generative AI model.
